(19) United States
(12) Patent Application Publication
(10) Pub. No.: US 2003/0030836 A1
(43) Pub. Date: Feb. 13, 2003

(54) Image processing apparatus for executing image process on the basis of job, or control method of controlling processing order of jobs

(76) Inventor: Shinichiro Maekawa, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/208,787

(22) Filed: Aug. 1, 2002

(30) Foreign Application Priority Data
Aug. 7, 2001 (JP) 239286/2001
Jul. 8, 2002 (JP) 198815/2002

(51) Int. Cl. B41F 1/00; G06F 15/00

(52) U.S. Cl. 358/1.14; 358/1.15

(57) ABSTRACT

It is prevented that a processing time of a print job which is interrupted becomes longer than it is needed. Particularly, when an amount of residual processes of the job which is interrupted is small, interruption is inhibited, thereby preventing a situation such that a process end time becomes longer than it is needed because the print job which is being processed is finished first.

### BACKGROUND OF THE INVENTION

1. Field of the Invention

The invention relates to an image processing apparatus having an interrupting function for interrupting a print job which is being processed by an interruption job inputted from an external apparatus or a processing method of interrupting the print job which is being processed by the inputted interruption job.

2. Related Background Art

In recent years, a system environment in which personal computers (hereinafter, abbreviated to “PCs”) and their image processing apparatus are connected via a network such as an LAN (Local Area Network) or the like and the image processing apparatus can be shared by the PCs has been constructed. As an image processing apparatus which can be shared by each PC, for example, there is a digital copying apparatus having functions of a copy, a print, and a facsimile transmission, a printer, or the like.

In the case where the image processing apparatus is shared, for example, in a same office, there are various use environments such that paper sizes to be outputted are different, output matter is often picked up soon or left for a long time. Further, the operation of the apparatus changes in accordance with time and circumstances. It is, therefore, necessary that the image processing apparatus copes with various operating methods.

As one means for enabling the apparatus to cope with the various operating methods, in recent years, an apparatus in which replacement of print jobs, an interruption print, or the like is performed by using a large capacity storing apparatus such as a hard disk or the like has been proposed. For example, if the interruption print is enabled by using such means, there is a case where output matter of a interruption job (print job on the side where it interrupts) and output matter of a normal job (print job whose interruption is not designated) are mixedly stacked onto a paper delivery tray.

Therefore, as a method of preventing the mixture stacking, there is a method shown in FIG. 22. FIG. 22 is a diagram schematically showing a construction of means for preventing a mixture stacking of the output matter of the interruption job and the output matter of the normal job on the paper delivery tray in a conventional image processing apparatus.

In the image processing apparatus, if the interruption job is generated during the operation of outputting the output matter of the normal job onto a paper delivery bin 2202 (after output matters 1, 2, and 3 were outputted), output matters 4 and 5 of the interruption job are outputted onto an upper paper delivery tray 2201. A control is made in a manner such that subsequent output matters 6 and 7 of the normal job are outputted to the paper delivery bin 2202 after the interruption job was outputted. Thus, a situation such that the output matter of the interruption job and the output matter of the normal job are mixedly stacked onto the paper delivery tray can be prevented.

### SUMMARY OF THE INVENTION

However, if the interruption job which causes a large quantity of output matters is issued during the output of the normal job, a process for the normal job is interrupted for a long time due to a print of a large quantity by the interruption job. Therefore, the user of the normal job has to wait for a long time. The user feels that use efficiency of an apparatus is low. The user of the interruption job and the user of the normal job become largely unfair.

It is, therefore, an object of the invention to make it possible to prevent a situation such that a processing end time of a job which is interrupted is delayed more than it is needed due to a process of a job which interrupts.

Particularly, when a residual amount of the process of the job which is interrupted is small, the interruption is inhibited and a print job which is being processed is finished first, thereby preventing the processing end time from being delayed more than it is needed.

### BRIEF DESCRIPTION OF THE DRAWINGS

FIG. 1 is a block diagram showing a construction of an image processing apparatus;

FIG. 2 is a vertical sectional view schematically showing the construction of the image processing apparatus;

FIG. 3 is a diagram schematically showing a flow of signals which are transmitted and received among a video controller, an engine controller, and an option controller, respectively;

FIG. 4 is a block diagram showing a construction of the video controller;

FIG. 5 is a diagram schematically showing a construction of a common memory of the option controller and the video controller;

FIG. 6 is a flowchart showing a procedure for allowing a video controller 103 to obtain a state regarding each option unit;

FIG. 7 is a diagram showing a flow of data which is sent from an external apparatus to the option controller and the engine controller;

FIG. 8 is a diagram showing a construction of a page table;

FIG. 9 is a diagram showing an engine state table;

FIG. 10 is a diagram showing a construction of a job table;

FIG. 11 is a flowchart showing a processing procedure for a job generation task;

FIG. 12 is a flowchart showing a processing procedure for a job control task;

FIG. 13 is a flowchart showing a procedure for an interruption permission discrimination;

FIG. 14 is a flowchart showing the procedure for the interruption permission discrimination;

FIG. 15 is a flowchart showing a processing procedure for an analysis development task;

FIG. 16 is a flowchart showing a processing procedure for a page operation task;

FIG. 17 is a diagram showing a flow of data which is sent from an external apparatus 101 to the option controller and the engine controller;

FIG. 18 is a flowchart showing a processing procedure for the job control task;

FIG. 19 is a flowchart showing a procedure for the interruption permission discrimination;

FIG. 20 is a flowchart showing the procedure for the interruption permission discrimination;

FIG. 21 is a flowchart showing a processing procedure for an analysis processing task;

FIG. 22 is a diagram schematically showing a construction of means for preventing a mixture stacking of output matter of an interruption job and output matter of a normal job; and

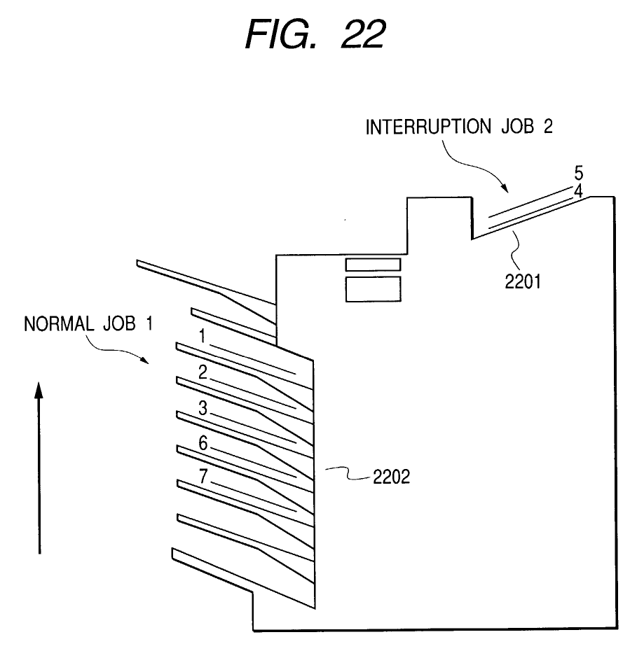

FIG. 23 is a table for explaining signals which are transmitted and received between the video controller an the engine controller.

### DETAILED DESCRIPTION OF THE PREFERRED EMBODIMENT

An embodiment of the invention will be described hereinbelow with reference to the drawings.

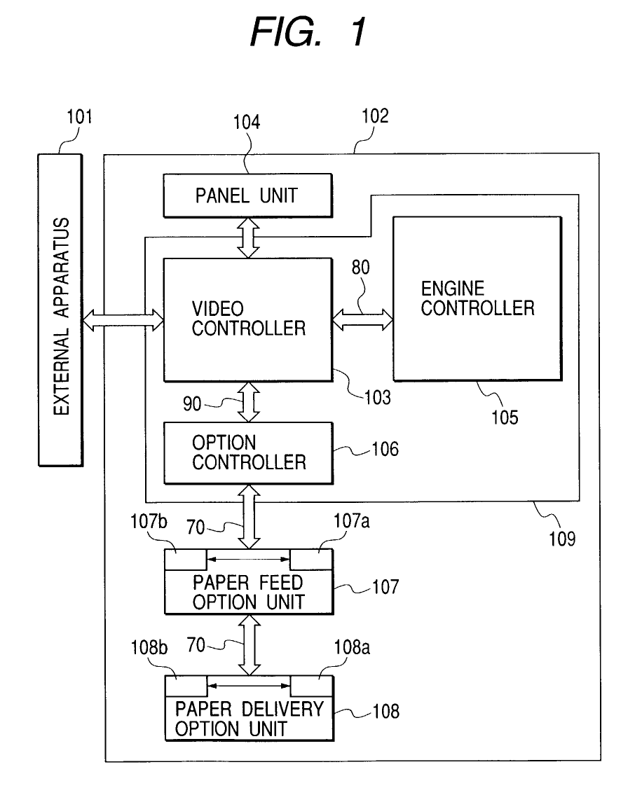

FIG. 1 is a block diagram showing a construction of an image processing apparatus according to the invention. In the embodiment, an example of a laser beam printer will be described as an image processing apparatus. The image processing apparatus is not limited to the laser beam printer but can be also applied to another printing apparatus such as ink jet printer. The invention can be also applied to an image processing apparatus such as copying apparatus having a copying function, hybrid apparatus having functions of a copy, a print, a facsimile transmission, and an image data transfer, or the like.

Although the invention will be explained hereinbelow with respect to a print job, the invention can be also applied to another job. For example, there is a copy job constructed by job data for controlling the copy, a scan job constructed by job data for controlling the scan, a data transfer job constructed by job data for controlling the image data transfer, or the like.

As shown in FIG. 1, each option unit can be connected to a laser beam printer (LBP) 102. The laser beam printer 102 is connected to an external apparatus 101 such as a host computer or the like via a general interface (for example, Centronics, RS232C, etc.) and records an image on the basis of print information (control information such as code data or the like based on a predetermined printer language: for example, it includes PostScript, LIPSIII, LIPSIV, image data, etc.) which is transferred from the external apparatus 101 via the general interface.

The laser beam printer 102 has a control unit 109. The control unit 109 comprises: a video controller 103 which is connected to the external apparatus 101 via the general interface; an engine controller 105; and an option controller 106.

The video controller 103 receives the code data transferred from the external apparatus 101 via the general interface and forms page information comprising dot data or the like on the basis of the code data. The page information transmits image data (binary or multivalue) to the engine controller 105 via a video interface 80 and transmits a paper feed designating command, a paper delivery designating command, and the like to the option controller 106 via a general control interface 90.

On the basis of image data (VDO signal) transferred from the video controller 103, the engine controller 105 forms an electrostatic latent image onto a photosensitive drum by a well-known electrophotographic process, develops the formed electrostatic latent image, and visualizes it as a toner image. The toner image is transferred onto supplied paper and fixed. The paper on which the toner image has been fixed is delivered to the outside. Upon image creation, the engine controller 105 issues a timing instruction of a paper feed or paper delivery or the like to the option controller 106.

An instruction is inputted from a panel unit 104 to the video controller 103. The panel unit 104 is an interface with the user, comprising: various switches (buttons) for operation; an LED display; an LCD display; and the like. By operating the panel unit 104, the user can instruct the laser beam printer 102 to execute a predetermined operation. Various data and the like set by the user are stored into a non-volatile memory (not shown) such as NVRAM, EEPROM, or the like.

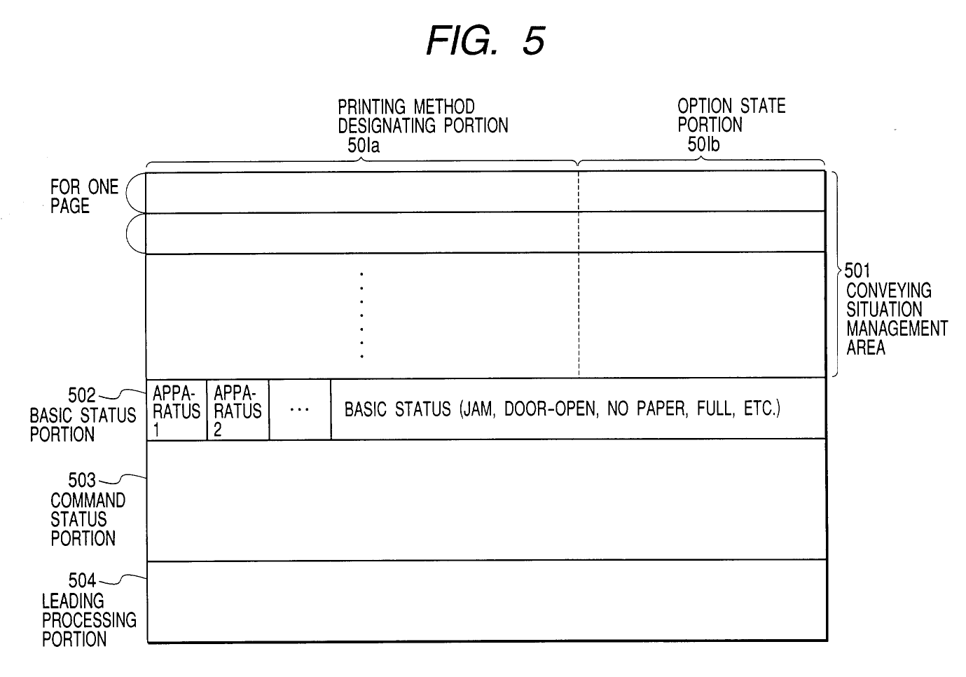

The option controller 106 is connected to the video controller 103 via the general control interface 90 so that it can communicate. The option controller 106 includes a CPU, an ROM, an RAM (not shown), and the like and integratedly controls one or more option units on the basis of the paper feed/delivery designating instructions or the like which are transferred from the video controller 103 via the general control interface 90 and the paper feed/delivery instructions or the like which are transferred from the engine controller 105. The option controller 106 communicates with various option units via an option unit interface 70 and integratedly controls the various option units. A common memory (shown in FIG. 5, which will be explained hereinlater) which can be accessed by the video controller 103 is provided in the RAM of the option controller 106. The common memory comprises: a conveying situation management area of about 40 pages; a basic status area; a command status management area; a leading processing area; and the like. The video controller 103 designates each option unit via each area in the common memory.

The conveying situation management area comprises: an area for allowing the video controller 103 to notify each option unit of a printing method (a paper feed port, a paper delivery port, a color, a stapling is executed, a shift is performed, etc.); and an area for notifying the video controller 103 of each option state (to which page the printing has been performed, a paper delivery has been completed, etc.). The basic status area is an area for notifying the video controller 103 of abnormality (JAM, no paper, no stapling needle, etc.) of each option unit. The command status management area is an area for transmitting and receiving a command status to/from the video controller 103. The leading processing area is an area for allowing the video controller 103 to designate a leading process of each option unit.

In the embodiment, a paper feed option unit 107 and a paper delivery option unit 108 are attached as option units. The paper feed option unit 107 is, for example, a paper deck option unit, has a paper deck controller (large capacity paper feed cassette controller) 107a therein, and performs a paper feed control on the basis of control information from the option controller 106. The paper deck controller 107a has a CPU, an ROM, and an RAM. The CPU controls the whole paper feed option unit 107 on the basis of a program stored in the ROM. Expansion information of the paper feed option unit 107, for example, information of a size of paper which can be enclosed into a paper deck and the like have been stored in the ROM.

The paper delivery option unit 108 is, for example, a sorter option unit having a sorting function, has a sorter controller (large capacity paper delivery sticker controller) 108a therein, and performs a sorting operation and a paper delivery operation on the basis of control information from the option controller 106. The sorter controller 108a has a CPU, an ROM, and an RAM. The CPU controls the whole paper delivery option unit 108 on the basis of a program stored in the ROM. Expansion information of the paper delivery option unit 108, that is, the following information has been stored in the ROM: for example, the number of paper delivery bins; the presence or absence of the sorting function; the presence or absence of the stapling function; the presence or absence of the shifting function to shift the delivery paper in a predetermined direction; a reversing function to reverse the direction of a face of the delivery paper; and the like.

Operation units 107b and 108b each having a display unit and various keys are provided for the paper feed option unit 107 and paper delivery option unit 108, respectively. Each of the operation units 107b and 108b is constructed in a manner such that messages to the user, an operating method, or the like at the time when each option unit is used can be displayed and the user can operate each option unit.

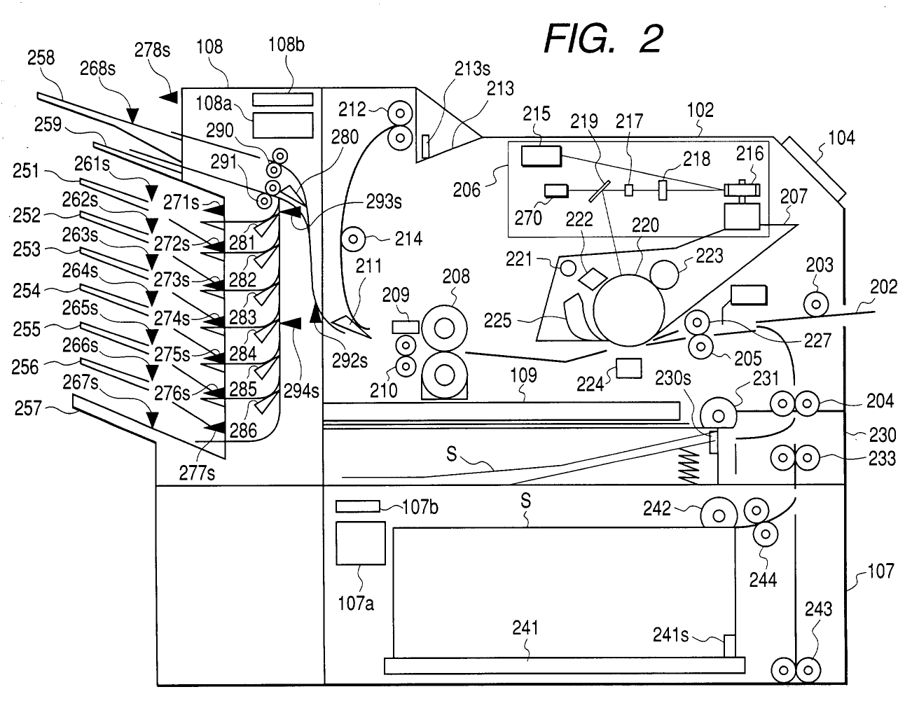

Subsequently, a construction of the laser beam printer 102 will be described with reference to FIG. 2. FIG. 2 is a vertical sectional view schematically showing the construction of the laser beam printer in FIG. 1.

As shown in FIG. 2, the laser beam printer 102 comprises: a laser scanner unit 206; an image recording unit 207; and the paper feed option unit 107. The laser scanner unit 206 has a laser unit 215 for emitting a laser beam on the basis of the image signal (VDO signal) which is sent from the video controller 103. The laser beam emitted from the laser unit 215 is scanned by a polygon mirror 216 and exposes a photosensitive drum 220 via an image forming lens group 218 and a return mirror 219. The laser beam emitted from the laser unit 215 is detected by a beam detector 217. A main scan sync signal is outputted in accordance with the detection. A light quantity of the laser beam is detected by a light quantity sensor 270.

The image recording unit 207 has the photosensitive drum 220 on which an electrostatic latent image is formed by the exposure of the laser beam. The following devices are arranged around the photosensitive drum 220: that is, a pre-exposure lamp 221 for removing charges from the surface of the photosensitive drum 220; a primary charging device 222 for uniformly charging the surface of the photosensitive drum 220; a developing device 223 for visualizing the electrostatic latent image formed on the photosensitive drum 220 to a toner image; a transfer device 224 for transferring the toner image formed on the photosensitive drum 220 onto recording paper S fed by a resist roller pair 205; and a cleaner 225 for removing residual toner on the photosensitive drum 220.

The recording paper S onto which the toner image has been transferred by the transfer device 224 is sent to a fixing device 208. The fixing device 208 presses the toner image on the recording paper S with heat, thereby fixing it onto the recording paper S. The recording paper S on which the toner image has been fixed is delivered from the fixing device 208 via a conveying roller 210. A paper delivery state of the recording paper S is detected by a paper delivery sensor 209.

A conveying direction of the recording paper S conveyed from the fixing device 208 is switched by a flapper 211 and, thereafter, the paper is guided to a conveying path for guiding it to a stacking tray 213 side or into the paper delivery option unit 108. Paper delivery rollers 214 and 212 are provided on the conveying path on the stacking tray 213 side. A delivery paper stack amount detecting sensor 213s is provided on the stacking tray 213.

The paper delivery option unit 108 has the sorter controller 108a and operation unit 108b mentioned above and has: a flapper 280 for switching the conveying direction of the recording paper S to the side of first to seventh paper delivery bins 251 to 257 or to the side of an eighth delivery bin 258; a paper delivery roller 290 for guiding the recording paper S from the flapper 280 to the eighth delivery bin 258; a reversal roller 291 for switching the recording paper S conveyed via the flapper 280 to a face-down state; a plurality of flappers 281 to 286 for guiding the recording paper S in the face-down state to the corresponding one of the paper delivery bins 251 to 257; and delivery paper-empty detecting sensors 261s to 268s and delivery paper-full detecting sensors 271s to 278s which are provided for the paper delivery bins 251 to 258, respectively.

The first to seventh paper delivery bins 251 to 257 are sorter bins for performing a sorter paper delivery in a face-down state. The eighth paper delivery bin 258 is a bin for performing a face-up paper delivery. The delivery paper-empty detecting sensors 261s to 268s are sensors for detecting the presence or absence of the recording paper S stacked in a corresponding one of the paper delivery bins 251 to 258, respectively. The delivery paper-full detecting sensors 271s to 278s are sensors each of which outputs a detection signal at a point when a height of recording paper S stacked in the corresponding one of the paper delivery bins 251 to 258 reaches a predetermined height, for example, 18 mm (corresponding to about 120 sheets of paper). The detection signals of the delivery paper-empty detecting sensors 261s to 268s and the delivery paper-full detecting sensors 271s to 278s are supplied from the sorter controller 108a to the video controller 103 via the option controller 106, respectively.

In the paper delivery option unit 108, a paper jam detecting sensor 292s is provided on the way of a conveying path in a range from the flapper 211 to the flapper 280, and paper jam sensors 293s and 294s are provided on the way of a path in a range from the flapper 280 to the paper delivery bins 251 to 257, respectively.

Further, the paper delivery option unit 108 has a stapler (not shown) for stapling a bundle of recording paper S and is constructed in a manner such that a stapling process for delivering the paper bundle stapled by the stapler onto a staple tray can be executed.

The recording paper S which is fed to the image recording unit 207 is supplied from a manual insertion tray 202, a sheet cassette 230, or the paper feed option unit 107. The manual insertion tray 202 is a tray for stacking the recording paper S to be manually fed. The recording paper S stacked on the tray 202 is conveyed to a resist shutter 227 by a manual insertion paper feed clutch 203. The recording paper S conveyed to the resist shutter 227 is conveyed toward the photosensitive drum 220 via the resist roller pair 205 at predetermined synchronizing timing.

The sheet cassette 230 is a cassette for enclosing the recording paper S. The recording paper S enclosed in the cassette 230 is fed by a paper feed clutch 231 and conveyed toward the resist shutter 227 via a conveying roller 204. A recording paper detecting sensor 230s for detecting an amount of enclosed recording paper S is provided for the sheet cassette 230.

The paper feed option unit 107 has the paper deck controller 107a and operation unit 107b as mentioned above and has: an elevatable paper deck 241 on which the recording paper S is stacked; a recording paper stack quantity detecting sensor 241s for detecting a stack quantity of the recording paper S on the paper deck 241; a paper feed roller 242 for feeding the recording paper S stacked on the paper deck 241; a conveying roller 244 for conveying the recording paper S which is fed from the paper feed roller 242 toward a conveying roller 233; and a relay conveying roller 243 for relay-conveying the recording paper S which is fed from another paper feeding system unit which is additionally provided in a lower portion of the paper feed option unit 107. The recording paper S conveyed from the paper feed option unit 107 via the conveying roller 233 is further conveyed toward the resist shutter 227 via the conveying roller 204.

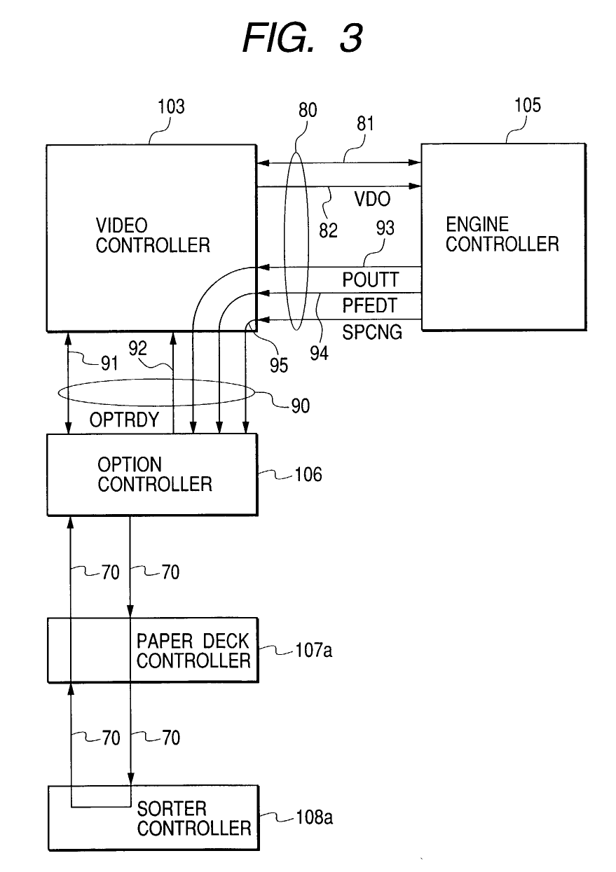

Subsequently, signals which are, respectively, transmitted and received among the video controller 103, engine controller 105, and option controller 106 will be described with reference to FIG. 3. FIG. 3 is a diagram schematically showing a flow of the signals which are, respectively, transmitted and received among the video controller 103, engine controller 105, and option controller 106 of the laser beam printer in FIG. 1.

As shown in FIG. 3, the general control interface 90 which connects the video controller 103 and option controller 106 includes a serial communication interface 91. The video controller 103 transmits a command for paper feed designation to the paper feed option unit 107, a command for paper delivery bin designation to the paper delivery option unit 108, and the like to the option controller 106 via the serial communication interface 91. Statuses such as no-paper state of the paper feed option unit 107, stacking state of each paper delivery bin of the paper delivery option unit 108, presence/absence state of staples, and the like are transmitted from the option controller 106 to the video controller 103 via the serial communication interface 91.

An OPTRDY signal 92 is sent from the option controller 106 to the video controller 103 via the general control interface 90. A POUTT signal 93, a PFEDT signal 94, and an SPCNG signal 95 are sent from the video controller 103 to the option controller 106. The OPTRDY signal 92 is a signal showing whether the option designated by the video controller 103, for example, the stapler is in a state where it can be used or not. The POUTT signal 93 is a signal which is sent from the engine controller 105 via the video controller 103 and shows timing for delivering the recording paper. The PFEDT signal 94 is a signal which is sent from the engine controller 105 via the video controller 103 and shows timing for receiving the recording paper. The SPCNG signal 95 is a signal which is sent from the engine controller 105 via the video controller 103 and used for reducing a conveying speed of the recording paper S conveyed at a high speed in the paper feed option unit 107, thereby matching it with a conveying speed in the laser beam printer 102.

The video interface 80 for connecting the video controller 103 and engine controller 105 includes a communication interface 81. The video controller 103 transmits a command for paper feed designation from the sheet cassette 230 of the laser beam printer 102 main body, a command for paper delivery designation to the paper delivery tray 213, a print command, and the like to the engine controller 105 via the communication interface 81. The engine controller 105 sends a status such as presence/absence, paper jam, or the like of the recording paper S in the sheet cassette 230, to the video controller 103 via the communication interface 81.

The video controller 103 sends a VDO signal 82 to the engine controller 105 via the video interface 80. The engine controller 105 sends the POUTT signal 93, PFEDT signal 94, and SPCNG signal 95 to the video controller 103 via the video interface 80.

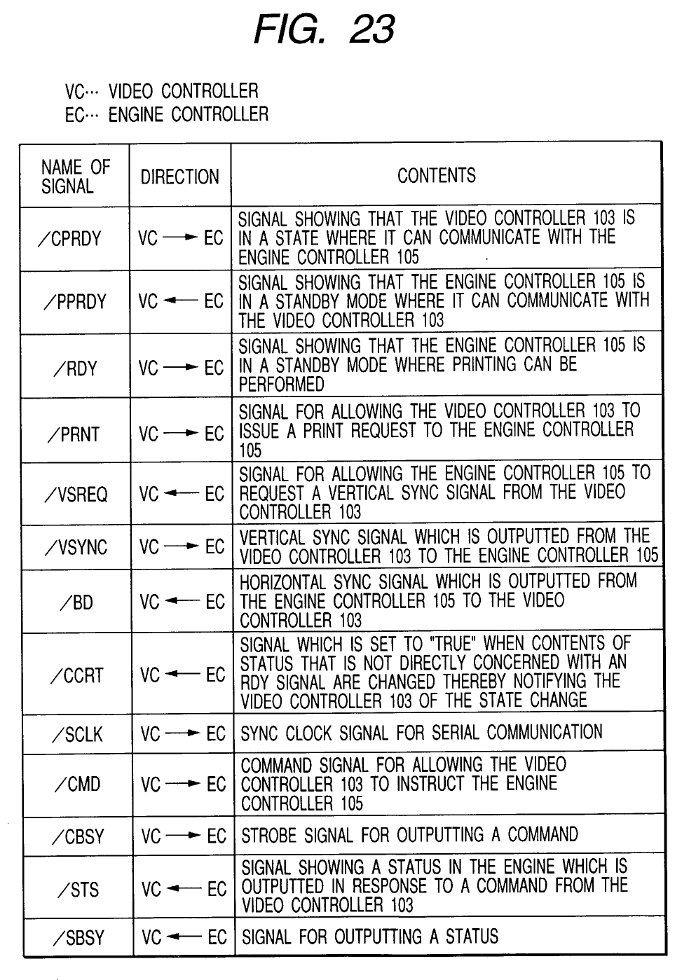

A control for each process by the engine controller 105 is executed on the basis of the following signals which are transmitted and received to/from the video controller 103: that is, /CPRDY, /PPRDY, /RDY, /PRNT, /VSREQ, /VSYNC, /BD, /SCLK, /CMD, /CBSY, /STS, /SBSY, and /CCRT (Condition Change Report) signals. FIG. 23 shows details of the above signals.

Among the above signals, a using method of the /CCRT signal will be described by using procedures 1 and 2 as examples.

(Procedure 1)

Usually, the video controller 103 checks the /RDY signal and the /CCRT signal. If there are changes in those signals, the video controller 103 reads out status information. In this instance, if the /CCRT signal is “FALSE” and the /RDY signal is “FALSE”, first, a status of contents such as misprint, wait, sleep, operator call, etc. is checked. In accordance with a result of the check, a lower status according to each bit is checked.

(Procedure 2)

If the /CCRT signal is “TRUE”, first, statuses of contents such as paper size change, paper feeding unit presence/absence change, paper feeding unit function change, warning contents change, etc. are read out. Kinds of changed statuses are recognized. The statuses of such a group are sequentially read out. Details are recognized. With respect to a resetting procedure of the /CCRT signal, the engine controller 105 always checks a status change of the end, that is, the change in paper size, the change in presence or absence of the paper, the change in paper feeding unit function, and the change in warning state. If there is a change, a state change status corresponding to the upper bit is set to “1” and the /CCRT signal serving as a hardware signal is set to “TRUE”. After that, when a status request command from the video controller 103 is received and the state change status is read out and stored into the video controller 103, the /CCRT signal is set to “FALSE”.

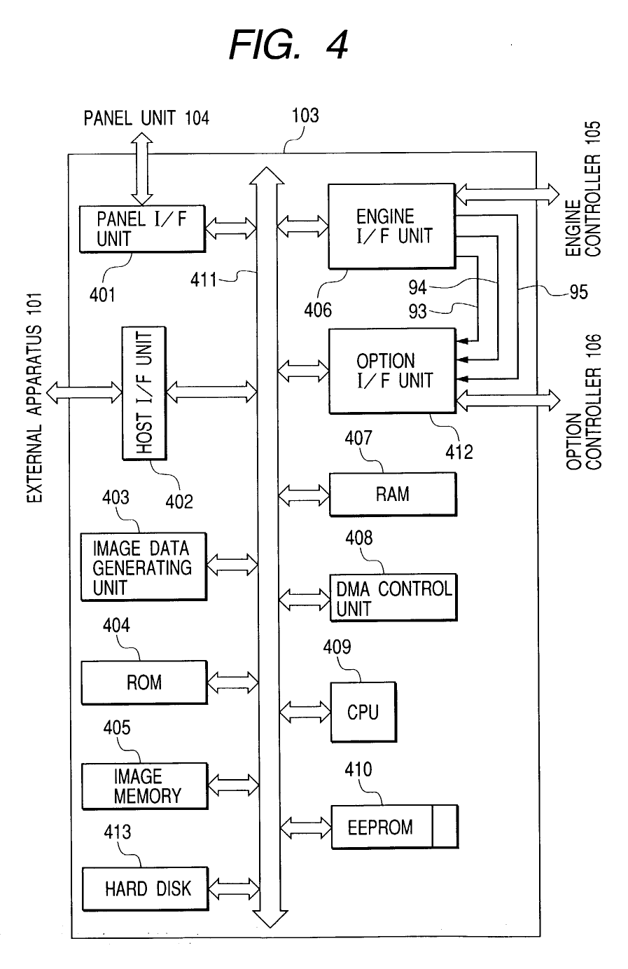

Subsequently, a construction of the video controller 103 will now be described with reference to FIG. 4. FIG. 4 is a block diagram showing the construction of the video controller 103 in FIG. 1.

As shown in FIG. 4, the video controller 103 has a host I/F unit 402 including an input buffer (not shown) for inputting code data transmitted from the external apparatus 101 and an output buffer (not shown) for temporarily holding a signal which is sent to the external apparatus 101. The host I/F unit 402 constructs an input/output unit of the signals which are transmitted and received to/from the external apparatus 101 and controls communication with the external apparatus 101.

The code data inputted via the host I/F unit 402 is sent to an image data generating unit 403. The image data generating unit 403 analyzes (for example, PDL analyzing process) the inputted code data on the basis of a predetermined analyzing procedure and forms image data which can be processed by the engine controller 105 from an analysis result.

The formed image data is stored into an image memory 405. The reading operation of the image data stored in the image memory 405 is controlled by a DMA control unit 408. A control for the reading operation of the image data from the image memory 405 by the DMA control unit 408 is performed on the basis of an instruction from a CPU 409.

The image data read out from the image memory 405 is transferred as a video signal (VDO signal) to the engine controller 105 via an engine I/F unit 406. The engine I/F unit 406 has: an output buffer (not shown) for temporarily holding the video signal which is transferred to the engine controller 105; and an input buffer (not shown) for temporarily holding the signal transmitted from the engine controller 105. The engine I/F unit 406 constructs an input/output unit of the signals which are transmitted and received to/from the engine controller 105 and controls communication with the engine controller 105.

The POUTT signal 93, PFEDT signal 94, and SPCNG signal 95 which are sent from the engine controller 105 are inputted to an option I/F unit 412 via the engine I/F unit 406. The option I/F unit 412 constructs an input/output unit of the signals which are transmitted and received to/from the option controller 106 and controls communication with the option controller 106.

An instruction regarding the mode setting which was outputted from the panel unit 104 (shown in FIG. 1) by the operation input and the like are inputted via a panel I/F unit 401. The panel I/F unit 401 constructs an interface between the panel unit 104 and the CPU 409.

The CPU 409 performs a control for each of the foregoing blocks in accordance with the mode instructed from the panel unit 104. This control is executed on the basis of a control program stored in an ROM 404. The control program stored in the ROM 404 is constructed by: an OS (Operating System) for executing a time divisional control on a unit basis of a load module called a task by a system clock; and a plurality of load modules which are executed and controlled on a function unit basis by the OS. The control program including those load modules is stored into an EEPROM (non-volatile memory) 410 as necessary. An RAM 407 is used as a work area for an arithmetic operating process which is executed by the CPU 409.

Those blocks including the CPU 409 are connected to a system bus 411 so that they can be accessed by the CPU 409. The system bus 411 is constructed by an address bus and a system bus.

Subsequently, a method whereby the video controller 103 integratedly controls the option units via the option controller 106 will be described with reference to FIG. 5. FIG. 5 is a diagram schematically showing a construction of a common memory of the video controller 103 assured in an RAM provided in the option controller 106 in FIG. 1.

The common memory (shown in FIG. 5) which is shared by the video controller 103 is assured in the RAM (not shown) provided in the option controller 106. The common memory comprises: a conveying situation management area 501 for designating a page and knowing a conveying situation of the paper; a basic status portion 502 for knowing an abnormal state of each option unit; a command status portion 503 for transmitting and receiving a command status; and a leading processing portion 504 for designating a leading process of the option unit.

The conveying situation management area 501 includes: a printing method designating portion 501a for storing designation information indicative of a paper feed port, a paper delivery port, color/monochromatic, stapling position, a printing method to be executed, and the like; and an option state portion 501b for storing states showing a paper feed situation of the paper, a permitting situation for an output of a print signal, a situation regarding completion of the paper delivery, and the like. The designation information of up to 40 pages can be stored into the printing method designating portion 501a and this portion is constructed as a ring buffer in which the designation is performed in page order. Thus, an area of the designation information in which the paper delivery has been completed is regarded as an empty area and initialized so that it can be designated again. The video controller 103 designates the foregoing designation information and executes a printing process with reference to each state of the option state portion 501b.

The basic status portion 502 stores a status for notifying the apparatus of an abnormal state of each option unit, for example, a status indicative of no paper, paper jam, door-open, full, or the like. The video controller 103 obtains the status of the basic status portion 502 and recognizes the abnormal state of each option unit.

The command status portion 503 is an area for storing detailed information of each option unit and a command status for controlling the operation of the option. For example, a name of the apparatus, a size of paper which is enclosed in the paper feeding unit, a residual quantity of paper in the paper feeding unit, a paper jam position, a kind, an access point, a stacking quantity of delivered paper, details of a failure, and the like are stored in the command status portion 503. Those information is obtained by a method whereby the video controller 103 issues a command in accordance with each situation. The command status portion 503 is also used for a control to each option unit, such as shift to a power saving mode, emergency stop upon paper jam, movement of the paper delivery bin, reset execution, or the like.

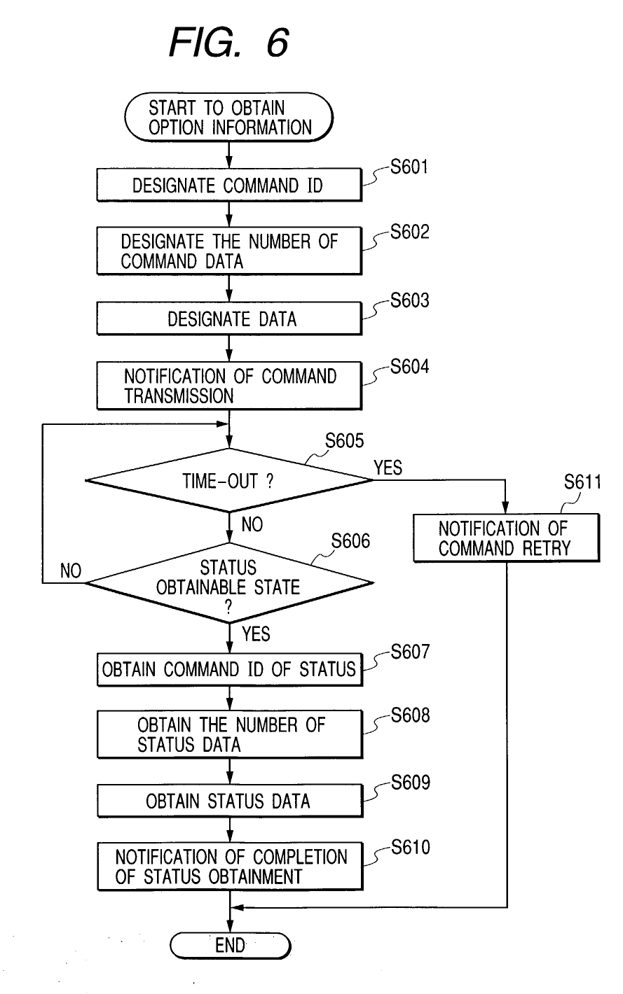

Subsequently, a procedure in the case where the video controller 103 accesses the common memory provided in the option controller 106 and obtains the state regarding each option unit will be described with reference to FIG. 6. FIG. 6 is a flowchart showing the procedure in the case where the video controller 103 in FIG. 1 accesses the common memory provided in the option controller 106 and obtains the state regarding each option unit.

When the video controller 103 accesses the common memory provided in the option controller 106 and obtains the state regarding each option unit, as shown in FIG. 6, first, in step S601, an ID for identifying a kind of necessary information is designated in the option controller 106. Subsequently, in step S602, the number of data which is obtained is designated in the option controller 106 by an execution command. In step S603, data showing designated contents is designated.

Subsequently, in step S604, the option controller 106 is notified of the command transmission. Thus, the option controller 106 makes serial communication with the corresponding option unit by using the above notification as a trigger and obtains the designated information from the corresponding option unit.

In response to the above notification, in the video controller 103, a timer for specifying a waiting time which is necessary until the option controller 106 obtains the information of the corresponding option unit is activated. In step S605, whether the timer has timed out or not is discriminated. If the timer does not time out, step S606 follows. Whether the option controller 106 is in a state where the status of the corresponding option unit can be obtained from the option controller 106 or not is discriminated. If the option controller 106 is not in the state where the status can be obtained, the processing routine is returned to step S605. If the option controller 106 enters the state where the status can be obtained until the timer times out, step S607 follows.

In step S607, the ID of the status corresponding to the designated command is obtained. Subsequently, in step S608, the number of status data is obtained. In step S609, status data as many as the number of status data is obtained.

The processing routine advances to step S610. The option controller 106 is notified of completion of the status obtainment.

In step S605, if it is determined that the timer has timed out before the option controller 106 enters the state where the status can be obtained, step S611 follows. A retry notification is performed so as to execute the command again.

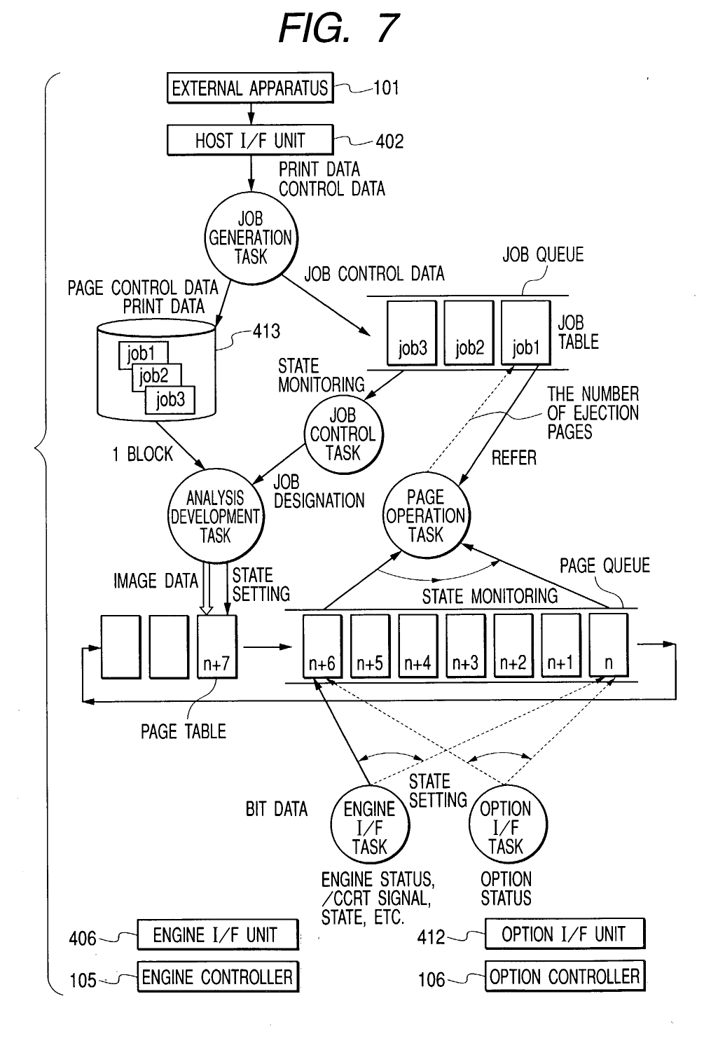

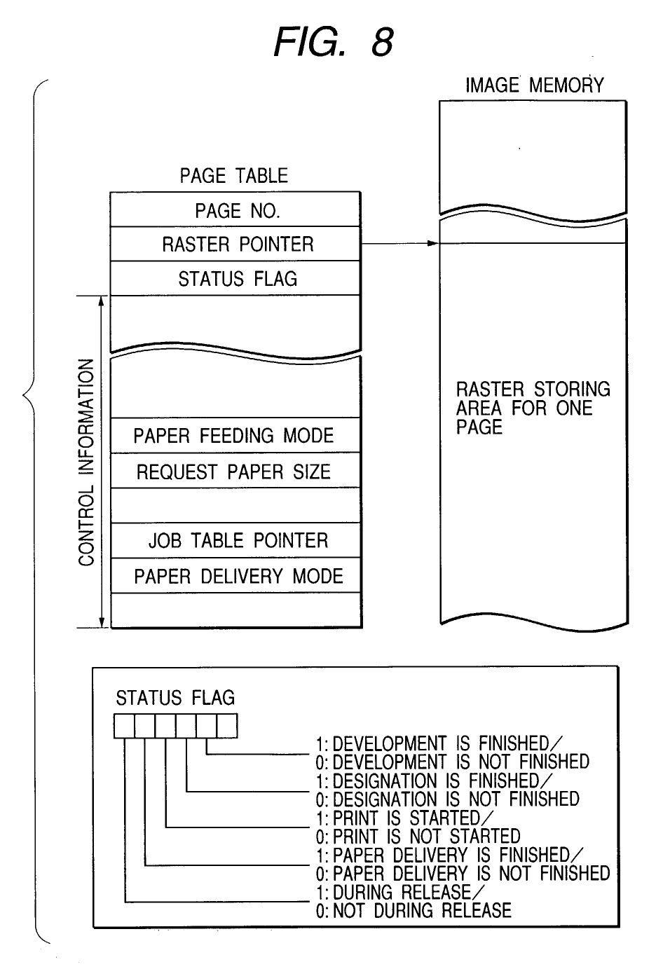

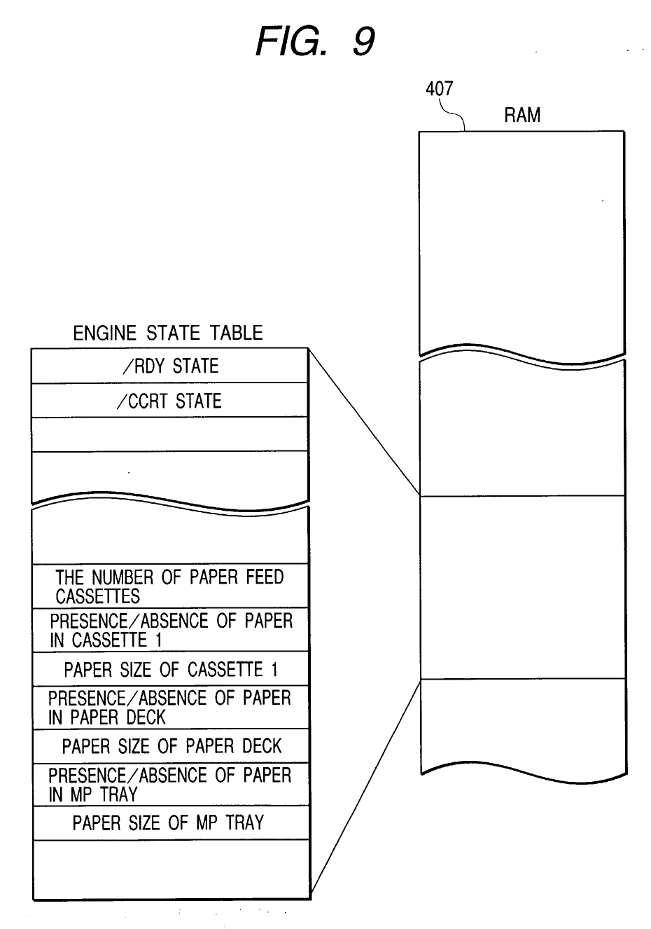

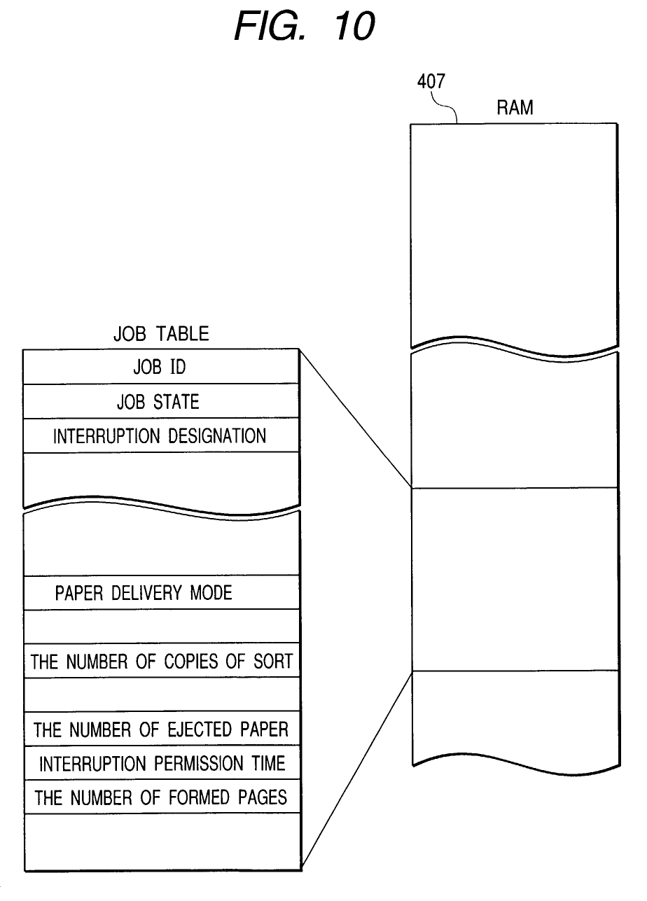

Subsequently, a flow of the data which is transmitted from the external apparatus 101 to the option controller 106 and the engine controller 105 will be described with reference to FIGS. 7 to 9. FIG. 7 is a diagram showing the flow of the data which is sent from the external apparatus 101 to the option controller 106 and the engine controller 105. FIG. 8 is a diagram showing a construction of a page table in FIG. 7. FIG. 9 is a diagram showing an engine state table which is stored into the PAM 407 of the video controller 103 in FIG. 1. FIG. 10 is a diagram showing a construction of a job table in FIG. 7.

As mentioned above, a control program which is executed by the CPU 409 is constructed by: the OS (Operating System) for executing the time divisional control on a unit basis of a load module called a task by a system clock; and a plurality of load modules which are executed and controlled on a function unit basis by the OS. As shown in FIG. 7, as tasks mentioned above, there are: a job generating system (job generation task), a job control system (job control task), a translator processing system (analysis development task), a scheduling system (page operation task), an engine I/F system (engine I/F task), and an option I/F system (option I/F task). Those tasks operate logically in parallel.

The job table is included in job control data which is generated by the job generation task. This job table is a table to store control information of each job. The job which is being processed in the job table is registered into a job queue and referred to. The control information of the page unit is stored into the page table. The page table which is being processed in the page table is registered into a page queue and referred to.

The page table is a table provided for the CPU 409 to logically recognize each page. A substance of the page table is stored into a predetermined area in the RAM 407 under the management of the CPU 409. As shown in FIG. 8, the page table is linked every image data of one page in the image memory 405 and includes a page number, a raster pointer, a status flag, and control information. The page number is information for unconditionally identifying the page. The raster pointer is a head pointer of an area in which the data of one page in the image memory has been stored. The CPU 409 divides the relevant area in the image memory 405 every page at the time of turn-on of a power source, thereby linking the raster pointer with the corresponding page area. The status flag is a flag showing a page state. As such flags, there are a development end flag, a designation end flag, a print start flag, a paper delivery end flag, and a release flag. The CPU 409 can discriminate in which state the page information formed by the status flag is.

The paper feeding mode included in the control information designates a paper feeding method by the paper feeding means. As paper feeding modes, there are “auto paper feed”, “cassette-1 (sheet cassette 230) paper feed”, “paper deck (paper feed option unit 107) paper feed”, “MP tray paper feed”, and the like.

For example, “auto paper feed” is a mode for preferentially feeding recording paper from the paper feeding means in which the recording paper of the designated size has been stacked. A numerical value of the paper size at which the paper feed is requested to the engine controller 105 is stored in a request paper size included in the control information. Further, a pointer of the job table to which the relevant page belongs is stored in a job table pointer included in the control information. The paper delivery mode has the same meaning as that of the area of the same name which a job table, which will be explained hereinlater, has.

Subsequently, an engine state table stored in the RAM 407 of the video controller 103 will be described with reference to FIG. 9.

The engine state table shows a state of the engine controller 105 grasped by the video controller 103. However, the state shown here is not the same as the actual state of the engine controller 105 but indicates the state of the engine controller 105 obtained by the communication at arbitrary timing. Each time the state of the engine controller 105 is obtained by the video controller 103, the state in the engine state table is updated to the obtained state.

As shown in FIG. 9, information indicative of, for example, a /RDY state, a /CCRT state, the number of paper feed cassettes, the presence/absence of the paper feed of the cassette 1, and the like has been stored in the engine state table. The /RDY state is a flag for reflecting a state of the /RDY signal and this flag is set to “TRUE” while the engine I/F task detects “FALSE” of the /RDY signal. The /CCRT state is a flag for reflecting a state of the /CCRT signal. The actual state of the /CCRT signal is reflected by the engine I/F task. The engine I/F task detects “TRUE” of the /CCRT signal and the state of the engine controller 105 is obtained by predetermined serial communication, so that the /CCRT state is set to “FALSE”.

The number of paper feed cassettes reflects attachment of an option cassette unit or the like and indicates the number of the paper feed cassettes which can be selected. The presence/absence of the paper feed of the cassette 1 shows the presence or absence of the recording paper in the sheet cassette 230. A paper size of the cassette 1 shows a paper size set by a dial in the sheet cassette 230. On the assumption that the user has already stacked the recording paper of the same size as that indicated by the dial value, the size of the recording paper stacked on the sheet cassette 230 is recognized from the paper size of the cassette 1. The presence/absence of the paper in the paper deck indicates the presence or absence of the recording paper in the paper feed option unit 107. A paper size of the paper deck is a paper size set by a partition plate (not shown) in the paper feed option unit 107. On the assumption that the user has already stacked the recording paper of the same size as that shown by a value of the partition plate of the paper feed option unit 107, the size of recording paper stacked in the paper feed option unit 107 is recognized from the paper size of the paper deck.

The engine state table is referred to from the analysis development task, the page operation task, the engine I/F task, and the option I/F task and updated.

A construction of the job table will now be described with reference to FIG. 10.

As shown in FIG. 10, the job table has been stored in the RAM 407 of the video controller 103. The job table is a table for allowing the CPU 409 to logically recognize each page. A job ID, a job state, an interruption designation, a paper delivery mode, the number of copies of sort, the number of ejected paper, an interruption permission time, the number of formed pages, and the like have been stored in the job table. The job ID is an ID for unconditionally identifying the job. The job state indicates an area for storing the flag showing the relevant job state. As such flags, there are a generation start flag, a generation end flag, an analysis instruction flag, an analysis end flag, a print instruction flag, a print end flag, a release instruction flag, a release end flag, and the like. In which state the formed page information is can be discriminated by the status flag. The interruption designation shows whether the relevant job indicates the interruption designation or not.

The paper delivery mode indicates a paper delivering method of the paper delivery means. As paper delivery modes, there are “bin-1 (the first paper delivery bin 251) paper delivery mode” to “bin-7 (the seventh paper delivery bin 257) paper delivery mode”, “main body FD (stacking tray 213) paper delivery mode”, “sort paper delivery mode”, “stack paper delivery mode”, and the like. The “sort paper delivery mode” is the same paper delivery mode as that of a mechanical type sort. The “stack paper delivery mode” is the same paper delivery mode as that of a stacking function of a large capacity. The number of copies of sort indicates the number of copies to be sorted in the sort paper delivery mode. The number of ejected paper indicates the number of paper obtained after completion of the print of the relevant job and the paper delivery. The interruption permission time indicates a time which is necessary for waiting for the end of the relevant job in the case where there is an execution request of the interruption job during the print of the relevant job. The number of formed pages indicates the number of pages obtained after completion of the analysis development of the relevant job.

A data flow shown in FIG. 7 will now be described.

As shown in FIG. 7, print data (control code, data described by the PDL, etc.) which is inputted from the external apparatus 101 is stored into the host I/F unit 402 on a predetermined block unit basis. When it is detected that data has been stored in the host I/F unit 402, the job generation task obtains the job table, registers the job table into a job queue, and sets the “analysis instruction flag” into “TRUE”. The job generation task analyzes the print data stored in the host I/F unit 402 on a block unit basis. While job control information (paper delivery mode) for the printer of the job unit is stored into the job table, the job generation task stores page unit control data (designation of the number of copies of the PDL, etc.) and image creation information (figure drawing command of the PDL, character code, etc.) onto a hard disk 413 on a block unit basis. In the embodiment, the above interruption permission time is included in the control information. If the job control information is not included in the data, the same items are set into the operation mode designating instruction from the panel unit 104, which will be explained hereinlater.

When it is confirmed that the job to be printed has been generated (existence of the job in which the “release instruction flag” of the job state in FIG. 10 is “TRUE”) in the job queue, the job control task notifies the analysis development task of the job to be printed, thereby activating.

When the instruction is received from the job control task, the analysis development task obtains the page table. The data is analyzed on a block unit basis. With respect to the image creation information (figure drawing command of the PDL, character code, etc.), the CPU 409 performs image development by using the image data generating unit 403 or by itself and stores the resultant data into an area shown by the raster pointer in the page table. With respect to page unit control information (the number of copies, paper feed selection, etc.) for the printer, it is stored into the page table. After completion of the analysis development of the data of one page, “end of development” in the page table is set to “TRUE” and enqueued into a page queue having an FIFO (First-In First-Out) structure.

A page operation task simultaneously monitors the status flags of all pages in the page queue, changes the conveying procedure in accordance with the states, and realizes the print. Upon printing, if the “paper delivery mode” differs from the just previous one, a message (paper removal call) to request the user to remove the recording paper stacked onto all of the bins (the first paper delivery bin 251 to the seventh paper delivery bin 257) is displayed by using the panel unit 104.

Upon print scheduling, paper feed designation for the paper feeding means, paper delivery designation and paper delivery processing mode designation for the paper delivery means, and the like are executed by the option I/F unit 412 on the basis of the information in the job table and the page table and, at the same time, the setup of the paper feeding means and the like is actually executed to the engine controller 105 by the engine I/F unit 406. In the page table in which the “paper delivery end flag” is “TRUE”, the page queue is dequeued. Further, the number of ejected paper in the job table to which the relevant page belongs is updated.

An engine I/F task and an option I/F task make communication at predetermined periods with the engine controller 105 and the option controller 106 via the engine I/F unit 406 and option I/F unit 412, respectively. If a factor of a change in state of the page is caused, the status flag is updated. The change in /RDY signal is monitored and for a change of “TRUE”→“FALSE”, the state of the printer is set to a state where an error has occurred, and cancellation of the error is monitored. Changes in states of the /RDY signal, /CCRT signal, and the like are monitored. The foregoing “procedure 1” and “procedure 2” are executed. The engine state table is updated.

The operation mode designation (the number of copies, paper feed selection, etc.) from the panel unit 104 is once stored into the panel I/F unit 401. As mentioned above, the interruption permission time is included in the operation mode designation. The panel control task (not shown) circularly monitors the panel I/F unit 401 at proper intervals. If the data exists, it is stored into the EEPROM 410 and, at the same time, it is stored as control information into a predetermined area in the RAM 407. Thus, even after the power source of the printer was once turned off, the printer can be made operative in a desired mode of the user.

Subsequently, the operation in the interruption printing mode of the job unit will be described with reference to FIG. 7.

If the job in which the “interrupting instruction” is “TRUE” is detected in the job queue, the job control task inquires of the analysis development task and the page operation task about whether the interruption is possible or impossible. If it is possible, the analysis development task and the page operation task are instructed to interrupt the print which is at present being executed. The data analysis is continued after a processing instruction of the relevant job was issued. If a residual processing time of the job which is interrupted in the judgment about whether the interruption is possible or impossible is shorter than a predetermined time, the interruption is not permitted and the inquiry is periodically repeated until the interruption is permitted.

When the print interrupting instruction is received, the analysis development task executes the process which is at present being executed until a predetermined point of time. Thereafter, the analysis developing process is interrupted. A designation job (interruption designation job) is newly received from the job control task and the process is restarted. If the interrupting instruction of the job which is being processed is ON, the paper delivery mode in the page table is set to the main body FD paper delivery mode irrespective of the designation.

When the print interrupting instruction is received, the page operation task stops the new print execution. After completion of the paper delivery of all of the designated pages, the residual page tables are abandoned and the page operation task waits for an instruction from the analysis development task. If “the number of ejected paper” of the job of the print executable page is equal to or larger than 1, the “paper removal call” is not displayed.

As mentioned above, the discrimination about whether the interruption is possible or not is made on the basis of the residual processing time of the job which is interrupted, thereby enabling the interrupting process to be executed in accordance with the residual processing time of the ordinary process.

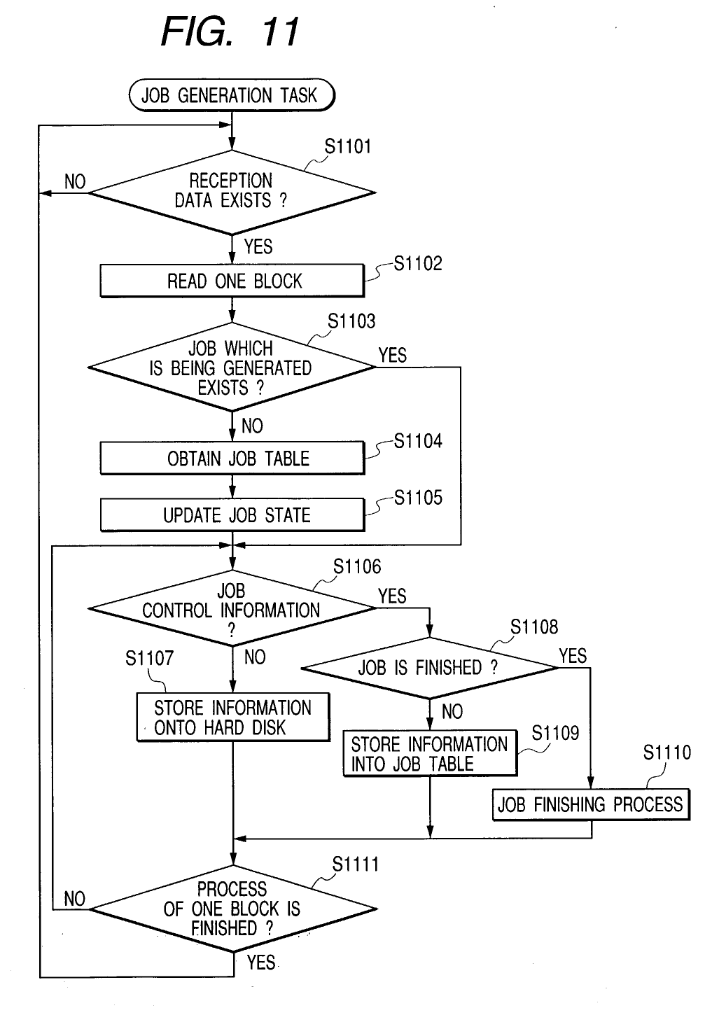

Processes by the job generation task will now be described with reference to FIG. 11. FIG. 11 is a flowchart showing a processing procedure of the job generation task in FIG. 7. The procedure shown in the diagram is executed by the CPU 409 in accordance with a control program stored in the ROM 404.

When the job generation task is activated upon turn-on of the power source, as shown in FIG. 11, in the job generation task, first, the host I/F unit 402 is inquired about the presence or absence of the reception data at predetermined periods in step S1101. If the reception data exists, in step S1102, the data of one predetermined block is read out from the host I/F unit 402 and stored into a work area for the CPU 409 in the RAM 407.

Subsequently, in step S1103, the presence or absence of the job table which is being generated is discriminated. If the job table which is being generated does not exist, a new job table is obtained in step S1104. In subsequent step S1105, the “analysis instruction flag” is set to “TRUE” and the job state is updated. The processing routine advances to step S1106. On the contrary, if the job table which is being generated exists, step S1106 follows.

Whether the processing data is job control information or not is discriminated in step S1106. If the processing data is the job control information, step S1108 follows and whether the data is a job end control code or not is discriminated. If the processing data is the job end control code, step S1110 follows. The “generation end flag” is set to “TRUE” and a completing process of the job table is executed. In step S1111, whether the process of the data of one block has been finished or not is discriminated. If the process has been finished, the processing routine is returned to step S1101. On the contrary, if the process is not finished yet, the processing routine is returned to step S1106.

If it is determined in step S1106 that the processing data is not the job control information, step S1107 follows. This data is stored onto the hard disk 413. In step S1111, whether the process of the data of one block has been finished or not is discriminated. If the process has been finished, the processing routine is returned to step S1101. If the process is not finished yet, the processing routine is returned to step S1106.

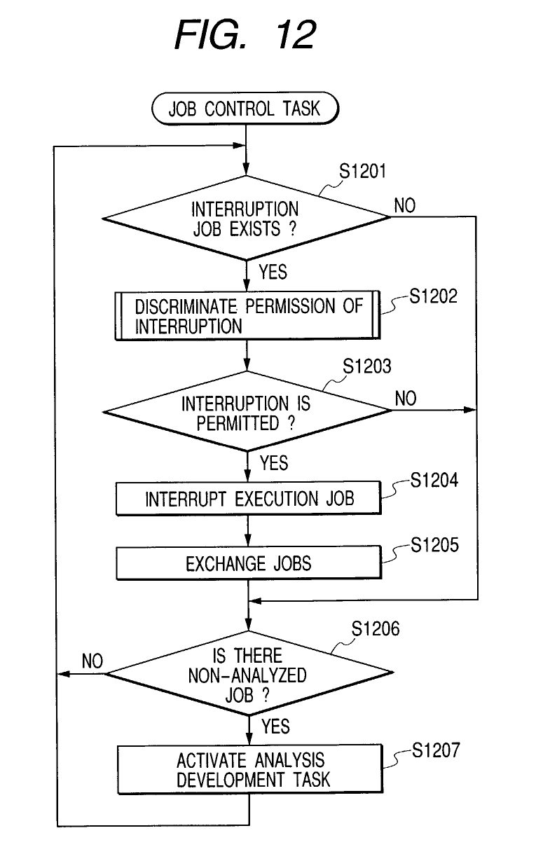

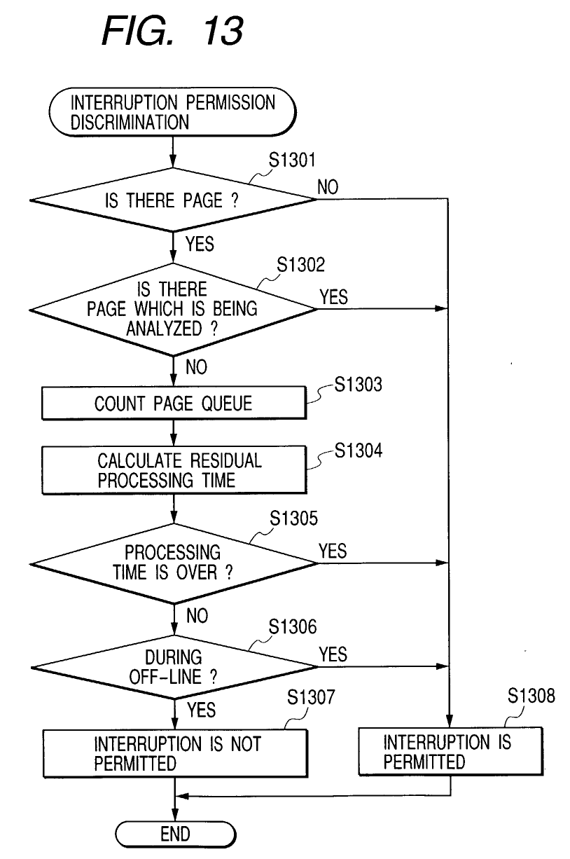

Subsequently, the processes of the job control task will be described with reference to FIGS. 12 and 13. FIG. 12 is a flowchart showing a processing procedure for the job control task in FIG. 7. FIG. 13 is a flowchart showing a procedure for the interruption permission discrimination in step S1202 in FIG. 12.

When the job control task is activated at the time of turn-on of the power source, as shown in FIG. 12, first, in step S1201, the job queue is searched and whether the “interrupting instruction” is “TRUE” or not is discriminated. If the “interrupting instruction” is “TRUE”, that is, when there is an interruption job, step S1202 follows. Interruption permission discrimination for discriminating whether the interruption is possible or not is made. Details of the interruption permission discrimination will be explained hereinlater. In step S1203, whether the interruption has been permitted or not is discriminated on the basis of a result of the interruption permission discrimination.

If the interruption of the job is permitted, the job which is at present being executed is interrupted in step S1204. In this instance, an execution stop instruction to the analysis development task and the page operation task is issued, thereby allowing those tasks to wait for the end of the execution. A job exchange for exchanging the interruption job to the head of the job queue is executed in step S1205.

Subsequently, step S1206 follows, the job queue is searched, and whether there is a non-analyzed job or not is discriminated. In this instance, whether there is a job in which the “analysis start instruction flag” is “TRUE” or not is discriminated. If there is not a non-analyzed job, the processing routine is returned to step S1201. If the non-analyzed job exists, step S1207 follows. In step S1207, the analysis development task is activated and the processing routine is returned to step S1201.

If it is determined in step S1201 that there is not an interruption job, step S1206 follows. If it is determined in step S1203 that the interruption is not permitted, step S1206 follows.

In the interruption permission discrimination in step S1202, the processes shown in FIG. 13 are executed. First, in step S1301, the page queue is searched and the presence or absence of the page table is discriminated. If the page table does not exist, the interruption is permitted in step S1308.

On the other hand, if the page table exists, in step S1302, whether there is a page table which is being analyzed or not is discriminated on the basis of the “analysis end flag” shown by the job table pointer in the page table. If the “analysis end flag” is not “TRUE”, it is determined that the page which is being analyzed exists, and the interruption is permitted in step S1308. If the page which is being analyzed exists, this means that the non-analyzed data remains, and the number of residual pages cannot be correctly obtained. Therefore, it is assumed that the interruption is permitted.

If the “analysis end flag” is “TRUE”, it is determined that the analysis has been finished. Step S1303 follows. The page queue is searched. The number of pages belonging to the same table as the job table is counted. The residual processing time of the job table is calculated from the number of residual pages. Assuming that a print time which is necessary for one page is set to Tp and the number of residual sheets is set to P, the residual processing time is calculated by the following equation.

Residual processing time=Tp×P

This print time Tp is a time which is determined by a processing speed of the printer.

Subsequently, in step S1304, whether the calculated residual processing time is longer or shorter than a preset interruption permission time (stored in the job table) is discriminated. If the calculated residual processing time is longer than the preset interruption permission time, the interruption is permitted in step S1308.

On the contrary, if the calculated residual processing time is shorter than the preset interruption permission time, step S1306 follows. Whether the printer is in an off-line state (state where the operation of the printer is stopped temporarily because an error is being displayed or the like) or not is discriminated. If the printer is in the off-line state, step S1308 follows and the interruption is permitted. If the printer is not in the off-line state, step S1307 follows and the interruption is not permitted.

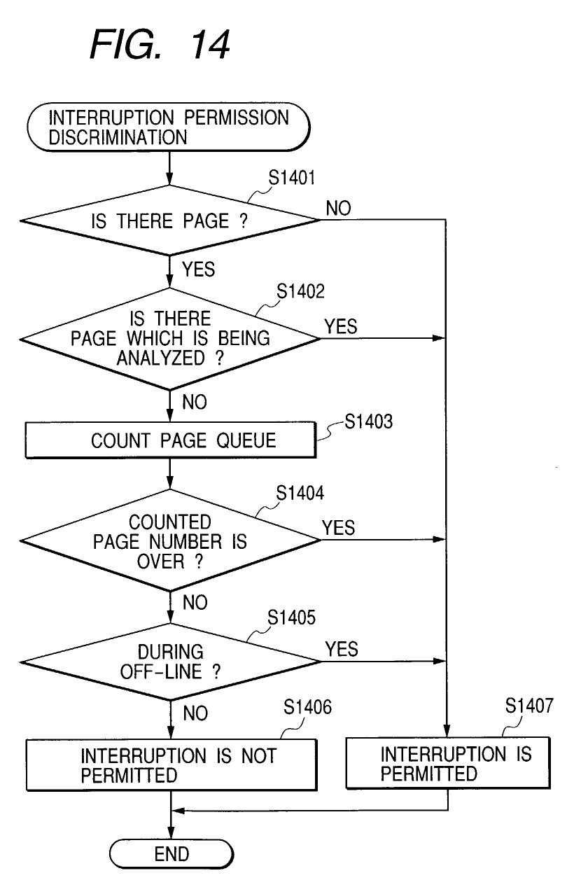

Although the permission or inhibition of the interruption has been discriminated on the basis of the residual processing time in FIG. 13, a similar effect can be also obtained even if it is discriminated by the number of residual sheets. FIG. 14 is a flowchart in the case where it is discriminated by the number of residual sheets.

First, in step S1401, the page queue is searched and whether there is a page table or not is discriminated. If there is not a page table, the interruption is permitted in step S1407.

On the other hand, if the page table exists, in step S1402, whether there is a page table which is being analyzed or not is discriminated on the basis of the “analysis end flag” shown by the job table pointer in the page table. If the “analysis end flag” is not “TRUE”, it is determined that there is a page which is being analyzed, and the interruption is permitted in step S1407. If the page which is being analyzed exists, this means that the non-analyzed data still remains, and the number of residual pages cannot be correctly obtained. Therefore, it is assumed that the interruption is permitted.

If the “analysis end flag” is “TRUE”, it is determined that the analysis has been finished, and step S1403 follows. The page queue is searched and the number of pages belonging to the same table as the job table is counted.

Subsequently, step S1404 follows. Whether the counted number of pages is larger or smaller than the preset number of interruption permitted pages is discriminated. If the counted number of pages is larger than the preset number of interruption permitted pages, the interruption is permitted in step S1407. If the counted number of pages is smaller than the preset number of interruption permitted pages, step S1405 follows. Whether the printer is in the off-line state (state where the operation of the printer is stopped temporarily because an error is being displayed or the like) or not is discriminated. If the printer is in the off-line state, step S1407 follows and the interruption is permitted. If the printer is not in the off-line state, step S1406 follows and the interruption is not permitted.

The number of pages in which the interruption is permitted is stored into the job table.

Although the number of residual pages has been obtained by counting the page queue in FIG. 14, there is a method of obtaining the number of residual pages on the basis of a difference between the total number of pages shown by the job data and the number of pages which have already been image-processed. As the number of pages which have already been image-processed, either the number of pages of the output matter or the number of pages of the image data formed by the analysis development task can be used. In this case, there is no need to make the discrimination in step S1402.

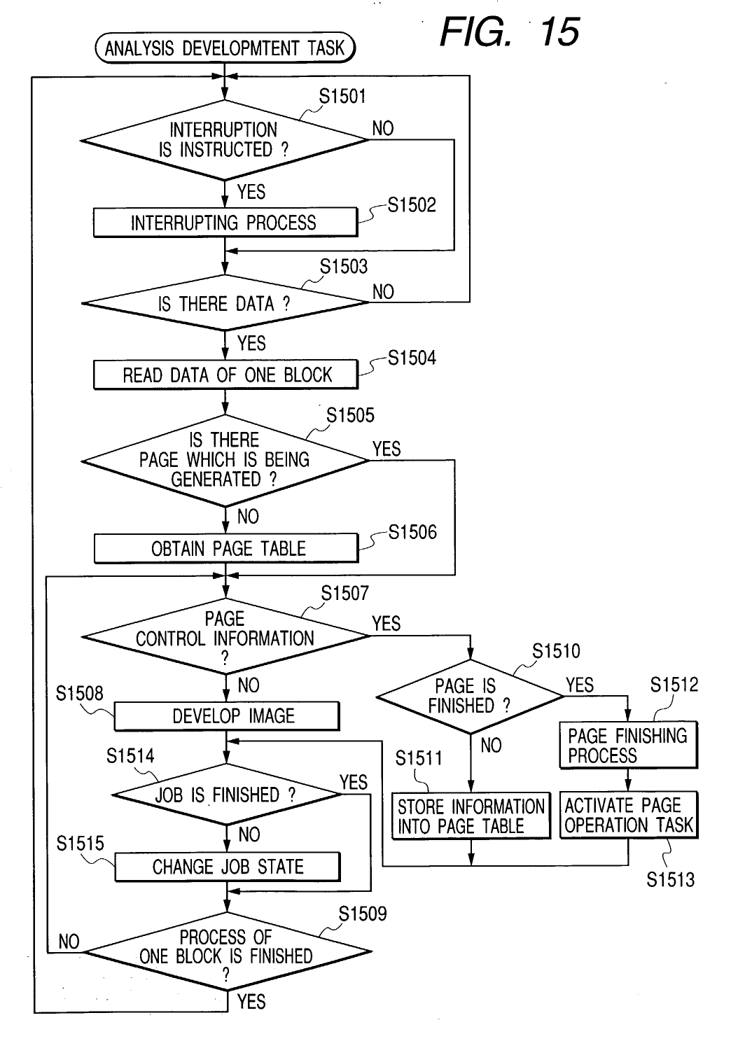

Subsequently, processes of the analysis development task will be described with reference to FIG. 15. FIG. 15 is a flowchart showing a processing procedure for the analysis development task in FIG. 7.

When the analysis development task is activated by the job control task, as shown in FIG. 15, first, in step S1501, the job control task is inquired about the presence or absence of the interrupting instruction at a predetermined period, thereby discriminating whether the interrupting instruction exists or not. If the interrupting instruction exists, an interrupting process is executed in step S1502. According to the interrupting process, page information and image information which are being formed are erased and the page table is released. In step S1503, the hard disk 413 is inquired about the presence or absence of the data. If there is no data, the processing routine is returned to step S1501. If it is determined in step S1501 that there is no interrupting instruction, step S1502 is skipped and the processing routine advances to step S1503.

If it is determined in step S1503 that the data exists on the hard disk 413, step S1504 follows. The data of one predetermined block is read out from the hard disk 413 and stored into a work area for the CPU 409 in the RAM 407. In step S1505, whether a page table which is being formed exists or not is discriminated. If the page table which is being generated does not exist, a new page table is obtained in step S1506. Step S1507 follows. On the other hand, if the page table which is being generated exists, step S1506 is skipped and the processing routine advances to step S1507.

In step S1507, the control codes and data in one block which were read out are sequentially discriminated and whether the processing data is the page control information or not is discriminated. If the processing data is the page control information, whether such information is a page ejection control code or not is discriminated in step S1510. If the information is the page ejection control code, step S1512 follows and a page finishing process is executed. In subsequent step S1513, the page operation task is activated, the page table is enqueued into the page queue, and the number of generated pages in the job table shown by the job table pointer in the page table is increased by “1”. Step S1514 follows. If it is decided in step S1510 that the information is the page ejection control code, step S1511 follows. The information corresponding to the page table is stored and step S1514 follows.

Whether the job has been finished or not is discriminated in step S1514. If the job is not finished yet, the “analysis end flag” in the job table of the relevant job is set to “TRUE” in step S1515 and step S1509 follows. If the job has been finished, step S1515 is skipped and step S1509 follows. Whether a data process of one block has been finished or not is discriminated in step S1509. If the data process of one block is not finished yet, the processing routine is returned to step S1507. If the data process of one block has been finished, the processing routine is returned to step S1501.

If it is decided in step S1507 that the processing data is not the page control information, step S1508 follows. Since the processing data is a code such as a PDL or the like, the image development is executed by the image data generating unit 403 or the CPU 409 itself. Step S1514 follows.

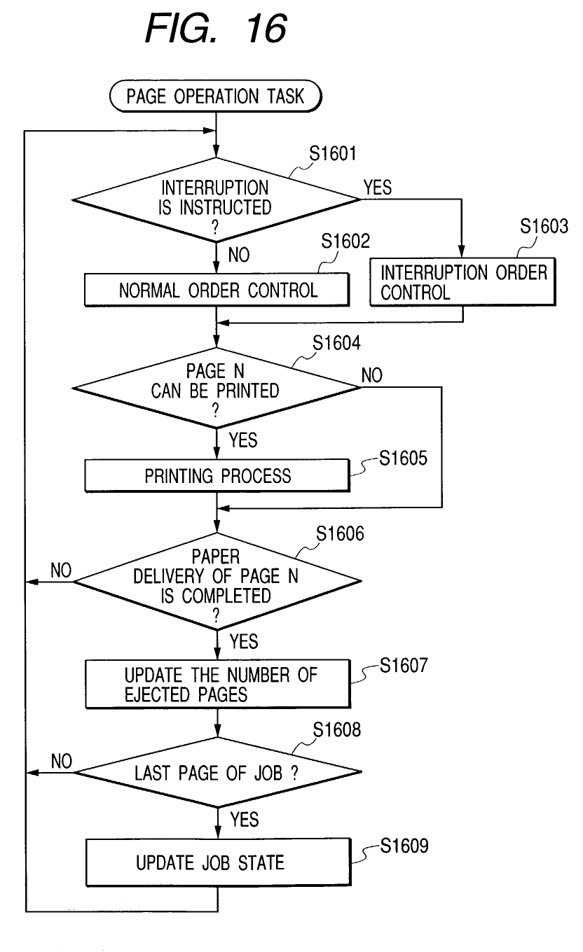

Processes of the page operation task will now be described with reference to FIG. 16. FIG. 16 is a flowchart showing a processing procedure for the page operation task in FIG. 7.

When the page operation task is activated by the analysis development task, as shown in FIG. 16, in step S1601, the job control task is inquired about the presence or absence of the interrupting instruction at a predetermined period, thereby discriminating whether the interruption has been instructed or not. If the interruption is not instructed, step S1602 follows and a normal order control is performed. Step S1604 follows. On the other hand, if the interruption has been instructed, step S1603 follows and an interruption order control is performed. The interruption order control is a control for preferentially ejecting all of the recording paper which are being conveyed in the printer. Finally, at a point when the recording paper which is being conveyed does not exist in the printer, the pages existing in the page queue are forcedly released. The processing routine advances to step S1604.

In S1604, states of all pages in the page queue are collated, thereby discriminating, for example, whether page N can be printed or not. If page N can be printed, a printing process is executed in step S1605, and step S1606 follows. On the contrary, if page N cannot be printed, step S1605 is skipped and step S1606 follows.

In step S1606, whether the paper delivery of page N has been completed or not is discriminated on the basis of the “paper delivery end flag” in the page table. If the paper delivery of page N is not completed, The processing routine is returned to step S1601. If the paper delivery of page N has been completed, step S1607 follows and “the number of ejected paper” in the job table is increased by “1”. In subsequent step S1608, whether the ejection of the last page of the relevant job has been completed or not is discriminated. If the ejection of the last page is not completed, the processing routine is returned to step S1601. On the other hand, if the ejection of the last page has been completed, step S1609 follows and the “print end flag” in the job table is set to “TRUE” and the processing routine is returned to step S1601.

As mentioned above, in the embodiment, if a residual processing time of the job which is being processed and is interrupted by another job is shorter than a time when the interruption is permitted (interruption permission time), the interruption is inhibited. Therefore, a situation such that the process of the job which is interrupted is made to wait for a long time by the interruption job and processing efficiency remarkably deteriorates can be prevented.

Particularly, when an amount of residual processes of the job which is interrupted is small, the interruption is inhibited and the print job which is being processed is finished first, thereby preventing the process end time from becoming longer than it is needed.

Since the interruption permission time can be set from the panel unit 104, the user can set an arbitrary interruption permission time. In an operation form such that a processing time of a job which is normally printed has been predetermined to a certain extent, the number of interrupting times can be properly set by such a setting.

Further, since the interruption permission time can be set on a job unit basis by using the job control information, even in an environment where a processing time per job is variable, an interruption rate can be flexibly determined.

Similarly, in the embodiment, if the number of residual pages in the job which is being processed and is interrupted by another job is smaller than the number of pages in which the interruption is permitted (the number of interruption permission pages), the interruption is inhibited. Therefore, a situation such that the process of the job which is interrupted is made to wait for a long time by the interruption job and processing efficiency remarkably deteriorates can be prevented.

Particularly, when an amount of residual processes of the job which is interrupted is small, the interruption is inhibited and the print job which is being processed is finished first, thereby preventing the process end time from becoming longer than it is needed.

Since the number of interruption permission pages can be set from the panel unit 104, the user can set an arbitrary number of interruption permission pages. The number of interrupting times can be properly set by such a setting.

Further, since the number of interruption permission pages can be set on a job unit basis by using the job control information, even in an environment where the number of pages per job is variable, an interruption rate can be flexibly determined.

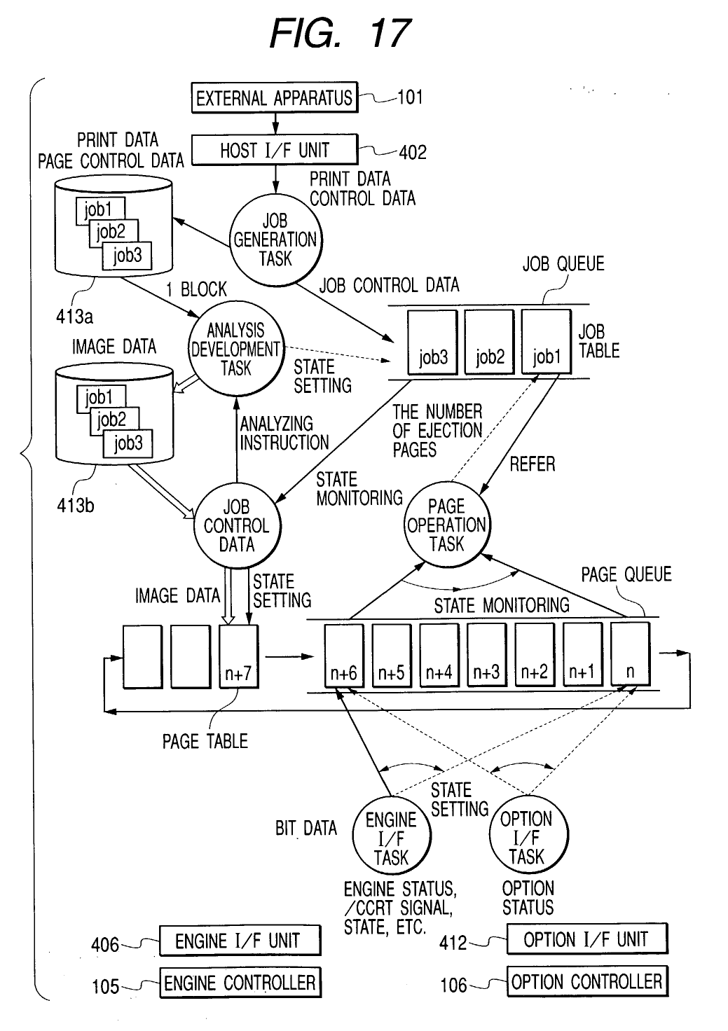

In the foregoing embodiment, the image data formed by the analysis development task can be also stored onto the hard disk. FIG. 17 is a diagram showing a flow of data which is transmitted from the external apparatus 101 to the option controller 106 and the engine controller 105 in such a case. In FIG. 17, the same or similar component elements as those in FIG. 7 are designated by the same reference numerals.

In FIG. 17, the image data is stored onto the hard disk 413 on a job unit basis. If there is an interruption job, whether the execution of the interruption job is permitted or inhibited is discriminated in accordance with the residual processing time of the job which is at present being executed.

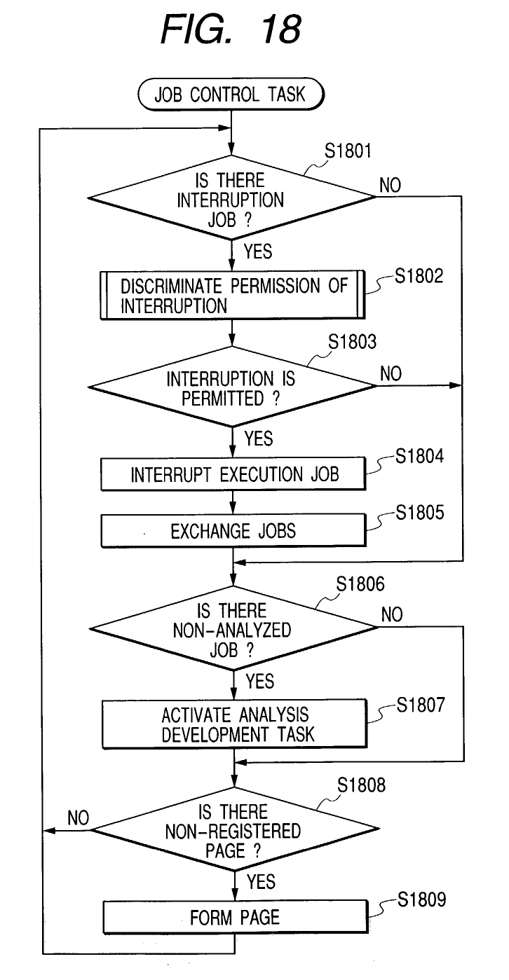

The print data (control code, PDL, etc.) which is inputted from the external apparatus 101 is obtained via the host I/F unit 402 and stored into a print data storing area 413a on the hard disk 413 on a predetermined block unit basis by the job generation task as shown in FIG. 18. The job generation task reads out the print data from the print data storing area 413a on the hard disk 413 on a block unit basis, analyzes, and stores page unit control data (designation of the number of copies of the PDL, etc.) and image creation information (figure drawing command of the PDL, character code, etc.) into an image data storing area 413b on the hard disk 413 on a block unit basis.

When an instruction from the job control task is received, the analysis development task obtains a temporary page table. The temporary page table has substantially the same structure as that of the page table shown in FIG. 8 and is stored into a predetermined area in the RAM 407. Subsequently, processes similar to those in FIG. 7 are executed. After completion of the analysis development of the data of one page, the data in the area shown by a raster pointer in the temporary page table is stored into the image data storing area 413b. The number of generation pages in the job table is increased.

In a manner similar to the foregoing first embodiment, the job control task activates the analysis development task. When it is recognized that a job table of “the number of generation pages>0” exists in the job queue, the job control task obtains the page table, reads out corresponding page table information from the image data storing area 413b, stores it, and sets it into the page queue.

Processes of the job control task in FIG. 17 will now be described with reference to FIG. 18.

When the job control task is activated at the time of turn-on of the power source, as shown in FIG. 18, first, in step S1801, the job queue is searched and whether the “interrupting instruction” is “TRUE” or not is discriminated. If the “interrupting instruction” is “TRUE”, that is, if there is an interruption job, step S1802 follows. Interruption permission discrimination to discriminate whether the interruption is possible or not is made. Details of the interruption permission discrimination will be explained hereinlater. In step S1803, whether the interruption has been permitted or not is discriminated on the basis of a result of the interruption permission discrimination.

When the interruption of the job is permitted, the job which is at present being executed is interrupted in step S1804. In this instance, an execution stop instruction to the analysis development task and the page operation task is issued, thereby making the end of those tasks to wait. In step S1805, a job exchange for exchanging the interruption job to the head of the job queue is executed.

Subsequently, in step S1806, the job queue is searched and whether there is a non-analyzed job or not is discriminated. Whether there is a job in which the “analysis start instruction flag” is “TRUE” or not is discriminated here. If the non-analyzed job exists, the analysis development task is activated in step S1807. Step S1808 follows. On the contrary, if the non-analyzed job does not exist, step S1807 is skipped and step S1808 follows.

In step S1808, a management table (not shown) in the image data storing area 413b is searched and whether there is a page which is not registered in the page queue or not is discriminated. If there is not a non-registered page, the processing routine is returned to step S1801. If the non-registered page exists, step S1809 follows. In step S1809, the page table is obtained and the data is copied and registered into the page queue. The processing routine is returned to step S1801.

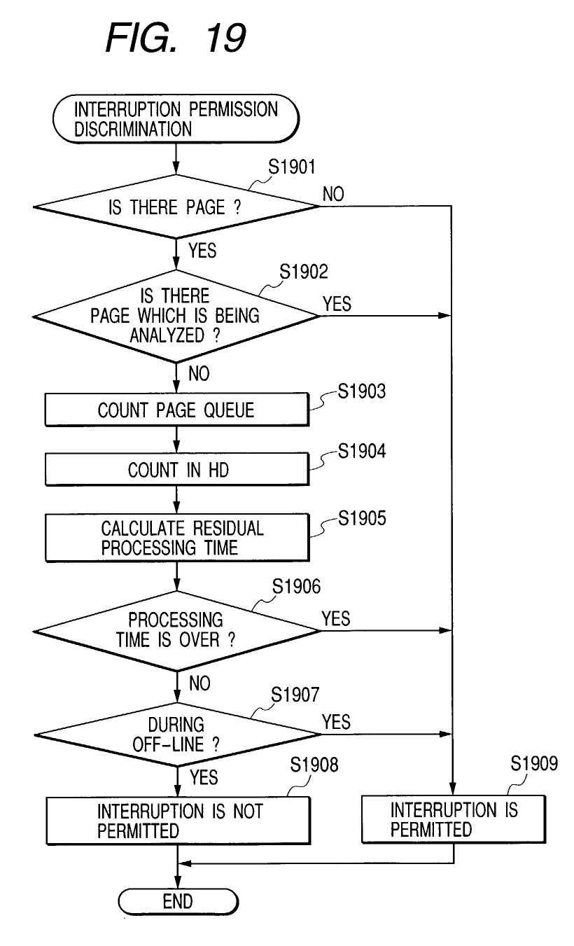

In the interruption permission discrimination in step S1802, as shown in FIG. 19, first, in step S1901, the page queue is searched and whether the page table exists or not is discriminated. If the page table does not exist, the interruption is permitted in step S1909.

On the contrary, if the page table exists, in step S1902, whether a page table which is being analyzed exists or not is discriminated on the basis of the “analysis end flag” shown by the job table pointer in the page table. If the “analysis end flag” is not “TRUE”, it is determined that the page which is being analyzed exists. The interruption is permitted in step S1909. If the “analysis end flag” is “TRUE”, it is determined that the analysis has been finished. Step S1903 follows. The page queue is searched and the number PA of pages belonging to the same table as the job table is counted. Subsequently, in step S1904, the management table in the image data storing area 413b is searched and the number PB of pages belonging to the same table as the job table is counted. In step S1905, “PA+PB” is set to the number of residual pages and a residual processing time of the job table is calculated. The calculation of the residual processing time is executed by using the above equation (1).

Subsequently, in step S1906, whether the calculated residual processing time is longer or shorter than the preset interruption permission time (stored in the job table) is discriminated. If the calculated residual processing time is longer than the preset interruption permission time, the interruption is permitted in step S1909. On the contrary, if the calculated residual processing time is shorter than the preset interruption permission time, step S1907 follows. Whether the printer is in the off-line state (state where the operation of the printer is stopped temporarily because an error is being displayed or the like) or not is discriminated. If the printer is in the off-line state, step S1909 follows and the interruption is permitted. If the printer is not in the off-line state, step S1908 follows and the interruption is not permitted.

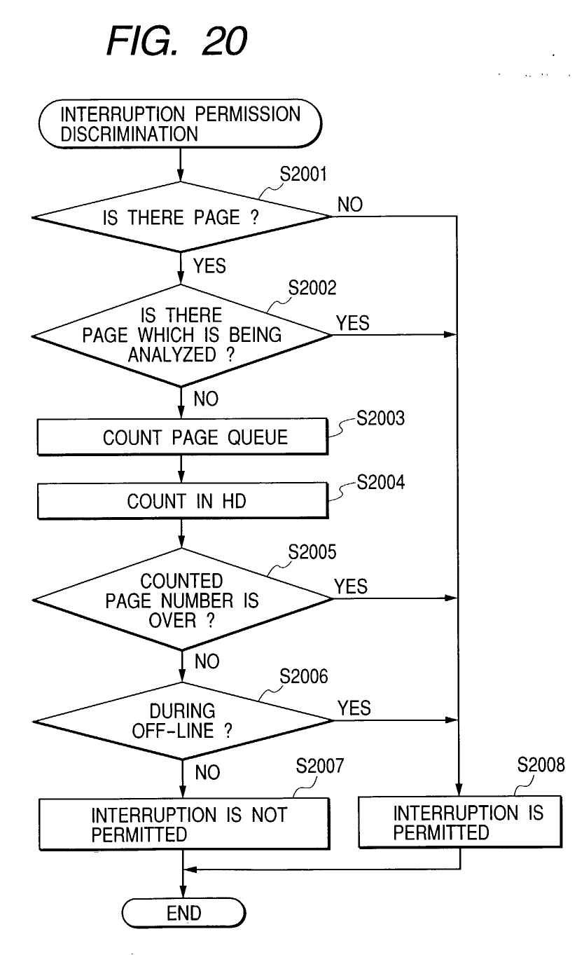

Although the permission or inhibition of the interruption has been discriminated on the basis of the residual processing time in FIG. 19, a similar effect can be also obtained even if it is discriminated on the basis of the number of residual pages. FIG. 20 is a flowchart in the case where it is discriminated on the basis of the number of residual pages.

As shown in FIG. 20, first, in step S2001, the page queue is searched and the presence or absence of the page table is discriminated. If the page table does not exist, the interruption is permitted in step S2008.

On the contrary, if the page table exists, whether a page table which is being analyzed exists or not is discriminated on the basis of the “analysis end flag” shown by the job table pointer in the page table in step S2002. If the “analysis end flag” is not “TRUE”, it is determined that the page which is being analyzed exists, and the interruption is permitted in step S2008.

If the “analysis end flag” is “TRUE”, it is determined that the analysis has been finished, and step S2003 follows. The page queue is searched and the number PA of pages belonging to the same table as the job table is counted. Subsequently, in step S2004, the management table in the image data storing area 413b is searched and the number PB of pages belonging to the same table as the job table is counted. “PA+PB” is equal to the number of residual pages.

Subsequently, in step S2005, whether the calculated number of residual pages is larger or smaller than the preset number of interruption permission pages is discriminated. If the calculated number of residual pages is larger than the preset number of interruption permission pages, the interruption is permitted in step S2008.

On the contrary, if the calculated number of residual pages is smaller than the preset number of interruption permission pages, step S2006 follows. Whether the printer is in the off-line state (state where the operation of the printer is stopped temporarily because an error is being displayed or the like) or not is discriminated. If the printer is in the off-line state, step S2008 follows and the interruption is permitted. If the printer is not in the off-line state, step S2007 follows and the interruption is not permitted.

The number of interruption permission pages is stored into the job table.

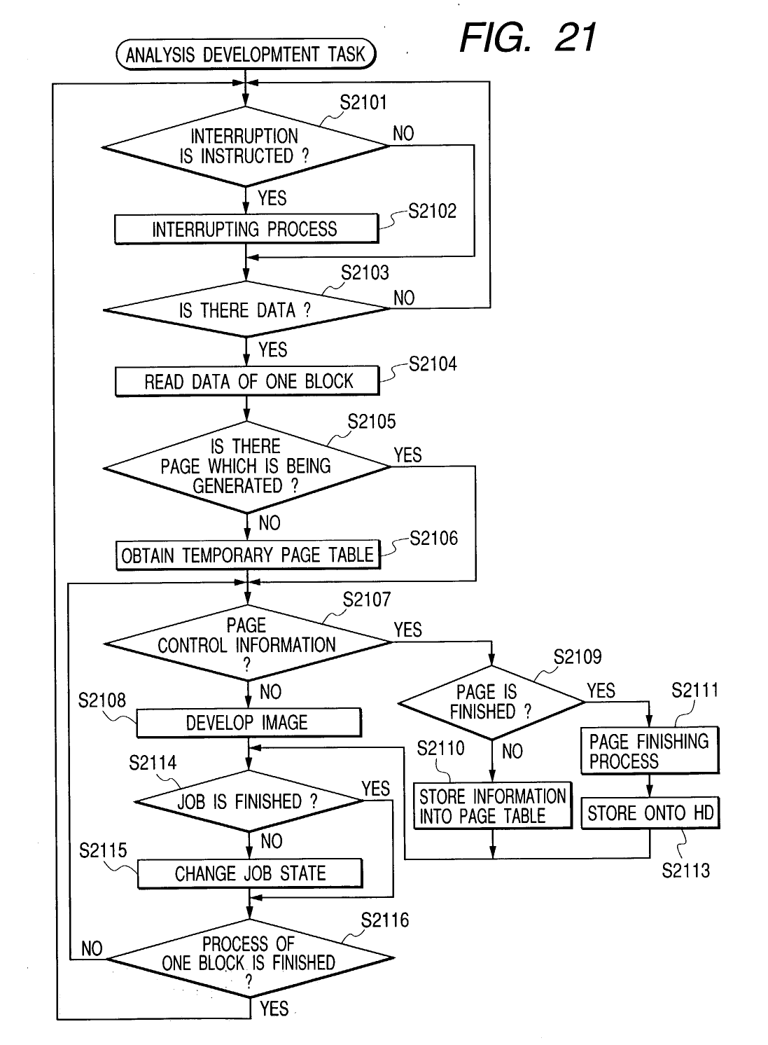

Processes of the analysis development task in FIG. 17 will now be described with reference to FIG. 21.

When the analysis development task is activated by the job control task, as shown in FIG. 21, first, in step S2101, the job control task is inquired about the presence or absence of the interrupting instruction at a predetermined period, thereby discriminating whether the interrupting instruction exists or not. If the interrupting instruction exists, the interrupting process is executed in step S2102. According to the interrupting process, page information and image information which are being formed are erased and the page table is released. In step S2103, the hard disk 413 is inquired about the presence or absence of the data. If there is no data, the processing routine is returned to step S2101. If it is determined in step S2101 that there is no interrupting instruction, step S2102 is skipped and the processing routine advances to step S2103.

If it is determined in step S2103 that the data exists on the hard disk 413, step S2104 follows. The data of one predetermined block is read out from the hard disk 413 and stored into the work area for the CPU 409 in the RAM 407. In step S2105, whether a page table which is being generated exists or not is discriminated. If the page table which is being generated does not exist, a new temporary page table is obtained in step S2106. Step S2107 follows. On the other hand, if the page table which is being generated exists, step S2106 is skipped and the processing routine advances to step S2107.

In step S2107, the control codes and data in one block which were read out are sequentially discriminated and whether the processing data is the page control information or not is discriminated. If the processing data is the page control information, whether such information is the page ejection control code or not is discriminated in step S2109. If the information is the page ejection control code, step S2111 follows and the page finishing process is executed. In subsequent step S2113, information in the temporary page table and data in an area shown by the table pointer in the temporary page table are stored into the image data storing area 413b, and the number of generation pages of the job table shown by the job table pointer in the page table is increased by “1”. Step S2114 follows. If it is determined in step S2109 that the information is the page ejection control code, step S2110 follows. Information corresponding to the page table is stored and step S2114 follows.

In step S2114, whether the job has been finished or not is discriminated. If the job is not finished, the “analysis end flag” in the job table of the relevant job is set to “TRUE” in step S2115, and step S2116 follows. On the other hand, if the job has been finished, step S2115 is skipped and step S2116 follows. Whether the data process of one block has been finished or not is discriminated in step S2116. If the data process of one block is not finished, the processing routine is returned to step S2107. If the data process of one block has been finished, the processing routine is returned to step S2101.

If it is determined in step S2107 that the processing data is not the page control information, step S2108 follows. Since the processing data is the code such as a PDL or the like, the image development is executed by the image data generating unit 403 or by the CPU 409 itself and step S2114 follows.

As mentioned above, the page queue is searched, the number PA of pages belonging to the same table as the job table is counted, the management table in the image data storing area 413b is searched, the number PB of pages belonging to the same table as the job table is counted, “PA+PB” is set to the number of residual pages, and the residual processing time is calculated on the basis of the number of residual pages. Therefore, the residual processing time of the job which is interrupted can be more accurately determined.

The page queue is searched, the number PA of pages belonging to the same table as the job table is counted, the management table in the image data storing area 413b is searched, the number PB of pages belonging to the same table as the job table is counted, and “PA+PB” is calculated as the number of residual pages. Therefore, the number of residual pages of the job which is interrupted can be more accurately determined.

Naturally, the invention is also accomplished by a method whereby a memory medium in which program codes of software for realizing the functions (including the flowcharts shown in the diagrams) of the foregoing embodiments have been recorded is supplied to a system or an apparatus, and a computer (or a CPU or an MPU) of the system or apparatus reads out the program codes stored in the memory medium and executes them.

In this case, the program codes themselves read out from the memory medium realize the functions of the embodiments mentioned above and the memory medium in which the program codes have been stored constructs the invention.

As a memory medium for supplying the program codes, for example, a floppy (R) disk, a hard disk, an optical disk, a magnetooptic disk, a CD-ROM, a CD-R, a magnetic tape, a non-volatile memory card, an ROM, or the like can be used.

Naturally, the invention incorporates not only a case where a computer executes the read-out program codes, so that the functions of the embodiments mentioned above are realized but also a case where the OS (Operating System) or the like which operates on the computer executes a part or all of the actual processes on the basis of instructions of the program codes, and the functions of the embodiments mentioned above are realized by those processes.

Further, naturally, the invention also incorporates a case where the program codes read out from the memory medium are written into a memory equipped for a function expanding board inserted in a computer or a function expanding unit connected to a computer and, thereafter, a CPU or the like provided for the function expanding board or function expanding unit executes a part or all of the actual processes on the basis of instructions of the program codes, and the functions of the embodiments mentioned above are realized by those processes.

What is claimed is:

1. An image processing apparatus for performing an image process in accordance with a job constructed by job data, comprising:
calculating means for calculating a time which is necessary until the image process is finished with respect to the job which is being image-processed; and
discriminating means for, in accordance with that an interruption job to which interruption has been instructed is inputted, discriminating whether the interruption of said interruption job is permitted or not on the basis of the time calculated by said calculating means,
wherein if it is determined by said discriminating means that the interruption is not permitted, the interruption of said interruption job is not performed.

2. An apparatus according to claim 1, further comprising:
generating means for analyzing the job data and forming image data of a page unit; and
storing means for storing the image data generated by said generating means on a job unit basis,
and wherein said calculating means calculates the time which is necessary until the image process is finished on the basis of the number of pages of the image data stored in said storing means and a processing time per page.

3. An apparatus according to claim 2, wherein if the job data which is not analyzed by said generating means among the job data corresponding to the job which is being image-processed exists, said discriminating means permits the interruption of said interruption job.

4. An apparatus according to claim 1, wherein if it is determined by said discriminating means that the interruption is permitted, the image process according to the job which is being image-processed is interrupted, and the image process according to said interruption job is started.

5. An apparatus according to claim 1, further comprising setting means for setting a time in which the interruption is permitted in accordance with the job data, a command from an external apparatus, or an input from operating means,
and wherein said discriminating means compares the time calculated by said calculating means with the time set by said setting means and discriminates whether the interruption is permitted or not.

6. An image processing apparatus for performing an image process in accordance with a job constructed by job data, comprising:
calculating means for calculating the number of residual pages existing until the image process is finished with respect to the job which is being image-processed; and
discriminating means for, in accordance with that an interruption job to which interruption has been instructed is inputted, discriminating whether the interruption of said interruption job is permitted or not on the basis of the number of residual pages calculated by said calculating means,
wherein if it is determined by said discriminating means that the interruption is not permitted, the interruption of said interruption job is not performed.

7. An apparatus according to claim 6, further comprising:
generating means for analyzing the job data and forming image data of a page unit; and
storing means for storing the image data generated by said generating means on a job unit basis,
and wherein said calculating means calculates the number of pages of the image data stored in said storing means.

8. An apparatus according to claim 6, wherein said calculating means compares the total number of pages shown by the job data with the number of pages which have already been image-processed and calculates the number of residual pages.

9. An apparatus according to claim 6, wherein if it is determined by said discriminating means that the interruption is permitted, the image process according to the job which is being image-processed is interrupted, and the image process according to said interruption job is started.

10. An apparatus according to claim 6, further comprising setting means for setting the number of pages in which the interruption is permitted in accordance with the job data, a command from an external apparatus, or an input from operating means,
and wherein said discriminating means compares the number of residual pages calculated by said calculating means with the number of pages set by said setting means and discriminates whether the interruption is permitted or not.

11. A control method of controlling processing order of a job when an image process is executed in accordance with the job constructed by job data, comprising:
a calculating step of calculating a time which is necessary until the image process is finished with respect to the job which is being image-processed; and
a discriminating step of, in accordance with that an interruption job to which interruption has been instructed is inputted, discriminating whether the interruption of said interruption job is permitted or not on the basis of the time calculated by said calculating step,
wherein if it is determined by said discriminating step that the interruption is not permitted, the interruption of said interruption job is not performed.

12. A method according to claim 11, further comprising:
a generating step of analyzing the job data and forming image data of a page unit; and
a storing step of storing the image data generated by said generating step on a job unit basis,
and wherein in said calculating step, the time which is necessary until the image process is finished is calculated on the basis of the number of pages of the image data stored by said storing step and a processing time per page.

13. A method according to claim 12, wherein in said discriminating step, it is determined that if the job data which is not analyzed by said generating step among the job data corresponding to the job which is being image-processed exists, the interruption of said interruption job is permitted.

14. A control method of controlling processing order of a job when an image process is executed in accordance with the job constructed by job data, comprising:
a calculating step of calculating the number of residual pages existing until the image process is finished with respect to the job which is being image-processed; and
a discriminating step of, in accordance with that an interruption job to which interruption has been instructed is inputted, discriminating whether the interruption of said interruption job is permitted or not on the basis of the number of residual pages calculated by said calculating step,
wherein if it is determined by said discriminating step that the interruption is not permitted, the interruption of said interruption job is not performed.

15. A method according to claim 14, further comprising:
a generating step of analyzing the job data and forming image data of a page unit; and
a storing step of storing the image data generated by said generating step on a job unit basis,
and wherein in said calculating step, the number of pages of the image data stored by said storing step is calculated.

16. A method according to claim 14, wherein in said calculating step, the total number of pages shown by the job data is compared with the number of pages which have already been image-processed and the number of residual pages is calculated.

17. A control program for controlling processing order of a job when an image process is executed in accordance with the job constructed by job data, wherein said program allows a computer to execute:
a calculating step of calculating a time which is necessary until the image process is finished with respect to the job which is being image-processed; and
a discriminating step of, in accordance with that an interruption job to which interruption has been instructed is inputted, discriminating whether the interruption of said interruption job is permitted or not on the basis of the time calculated by said calculating step,
and if it is determined by said discriminating step that the interruption is not permitted, the interruption of said interruption job is not performed.

18. A control program for controlling processing order of a job when an image process is executed in accordance with the job constructed by job data, wherein said program allows a computer to execute:
a calculating step of calculating the number of residual pages existing until the image process is finished with respect to the job which is being image-processed; and
a discriminating step of, in accordance with that an interruption job to which interruption has been instructed is inputted, discriminating whether the interruption of said interruption job is permitted or not on the basis of the number of residual pages calculated by said calculating step,
and if it is determined by said discriminating step that the interruption is not permitted, the interruption of said interruption job is not performed.
